(19) United States
(12) Patent Application Publication
(10) Pub. No.: US 2021/0359514 A1
(43) Pub. Date: Nov. 18, 2021

(54) INFORMATION PROCESSING APPARATUS AND JOB SCHEDULING METHOD

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/186,253

(22) Filed: Feb. 26, 2021

(30) Foreign Application Priority Data
May 18, 2020 (JP) 2020-087048

(51) Int. Cl. H02J 3/00; G05F 1/66; H02J 3/14

(52) U.S. Cl. CPC H02J 3/003; H02J 3/14; G05F 1/66

(57) ABSTRACT

A process includes calculating a first predicted-power-consumption obtained by predicting a first power-consumption of a first job in a first period based on information before the first period, when an error between the first power-consumption and the first predicted-power-consumption is less than a threshold-value, at time of scheduling to allocate second jobs to calculation-nodes so that a total estimated-power-consumption in a second period after the first period of each of the second jobs including the first job allocated to the calculation-nodes is equal to or less than a predetermined first power, determining a first estimated-power-consumption of the first job in the second period, as a second predicted-power-consumption obtained by predicting a power-consumption when the first job is executed in the second period, and when the error is equal to or larger than the threshold-value, determining the first estimated-power-consumption at the time of the scheduling as a predetermined second power.

### CROSS-REFERENCE TO RELATED APPLICATION

This application is based upon and claims the benefit of priority of the prior Japanese Patent Application No. 2020-087048, filed on May 18, 2020, the entire contents of which are incorporated herein by reference.

### FIELD

The embodiments discussed herein are related to an information processing apparatus and a job scheduling method.

### BACKGROUND

A large-scale computer system (hereinafter, also referred to simply as a system) such as a high performance computing (HPC) system consumes a large amount of power. Therefore, in order to operate the system stably, it is important to appropriately manage the power consumption of the system.

In addition, there may be an upper limit on the power that may be used for the entire system. In this case, a job scheduling is executed based on the power consumption of each job under execution in the system so that the power consumption does not exceed the power available for the entire system.

As a technique related to the job scheduling based on the power consumption, there has been proposed a system for dynamic temporal power steering that provides a dynamic power steering including, for example, a step of determining a phase sequence of an application in a node. In addition, there has also been proposed a computer in which another process is selected and executed when the power consumption within a unit time exceeds predetermined power consumption. Further, there has also been proposed an energy management server that enables a creation of a highly accurate operation schedule for a demand response signal.

Related technologies are disclosed in, for example, Japanese National Publication of International Patent Application No. 2018-503184 and Japanese Laid-Open Patent Publication Nos. 07-168726 and 2015-012783.

### SUMMARY

According to an aspect of the embodiments, a non-transitory computer-readable recording medium having stored job scheduling program that causes a computer to execute a process, the process includes calculating a first predicted power consumption obtained by predicting a power consumption of a first job in a first period based on information before the first period, when an error between the power consumption of the first job in the first period and the first predicted power consumption is less than a threshold value, at time of scheduling to allocate one or more second jobs to a plurality of calculation nodes so that a total estimated power consumption in a second period after the first period of each of the one or more second jobs including the first job allocated to the plurality of calculation nodes is equal to or less than a predetermined first power, determining an estimated power consumption of the first job in the second period, as a second predicted power consumption obtained by predicting a power consumption when the first job is executed in the second period, and when the error is equal to or larger than the threshold value, determining the estimated power consumption of the first job in the second period at the time of the scheduling as a predetermined second power.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a job scheduling method according to a first embodiment;

FIG. 2 is a diagram illustrating a system configuration example of a second embodiment;

FIG. 3 is a diagram illustrating a configuration example of hardware of an HPC operation management server;

FIG. 4 is a diagram for explaining a recurrent neural network (RNN);

FIG. 5 is a block diagram illustrating the functions of the HPC operation management server;

FIG. 6 is a diagram illustrating an example of information stored in a database;

FIG. 7 is a diagram illustrating an example of job information;

FIG. 8 is a diagram illustrating an example of job power consumption information;

FIG. 9 is a diagram illustrating an example of sample data;

FIG. 10 is a diagram illustrating an example of learning result information used for power consumption prediction of a job under execution;

FIG. 11 is a diagram illustrating an example of learning result information used for power consumption prediction of a job before execution;

FIG. 12 is a diagram illustrating an example of similar job information;

FIG. 13 is a diagram illustrating an example of determination information;

FIG. 14 is a diagram illustrating an example of estimation result information;

FIG. 15 is a diagram illustrating an example of a method of specifying estimated power consumption of a job before execution;

FIG. 16 is a diagram illustrating an example of a method of generating a queue indicating a priority;

FIG. 17 is a diagram illustrating an example of a method of specifying estimated power consumption of a job under execution;

FIG. 18 is a diagram illustrating an example (reference example) of generation of a data set;

FIG. 19 is a diagram illustrating a first example of generation of a data set;

FIG. 20 is a diagram illustrating a second example of generation of the data set;

FIG. 21 is a diagram illustrating a third example of generation of the data set;

FIG. 22 is a diagram illustrating the outline of a prediction model generating process;

FIG. 23 is a diagram illustrating an example of a prediction model;

FIG. 24 is a flowchart illustrating an example of a determination information generating process procedure;

FIG. 25 is a flowchart illustrating an example of a prediction model generating process procedure;

FIG. 26 is a flowchart illustrating an example of a before-execution power estimating process procedure;

FIG. 27 is a flowchart illustrating an example of an execution ratio adjusting process procedure;

FIG. 28 is a flowchart illustrating an example of an under-execution power estimating process procedure;

FIG. 29 is a flowchart illustrating an example of a job scheduling process procedure; and

FIG. 30 is a diagram illustrating an example of comparing scheduling methods.

### DESCRIPTION OF EMBODIMENTS

As for an estimated power consumption of a job at the time of scheduling, for example, it is conceivable to set the upper limit of the power consumption of a calculation node that executes the job. Then, since the actual power consumption of the job does not exceed the upper limit of the power consumption of the calculation node used, the actual power consumption of the entire system does not exceed the power available for the entire system. However, when a difference between the actual power consumption of the job and the upper limit of the power consumption of the calculation node used is relatively large, the power efficiency of the system will decrease.

Hereinafter, embodiments of techniques capable of improving the power efficiency of a system will be described with reference to the accompanying drawings. Further, these embodiments may be implemented in proper combination unless contradictory from each other.

### First Embodiment

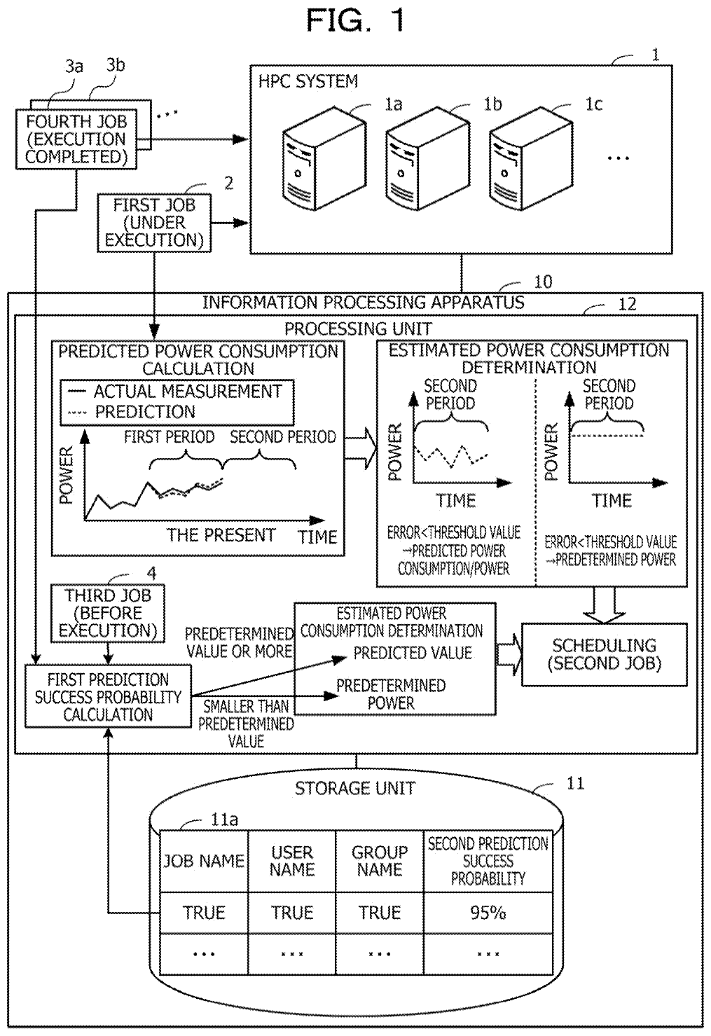

First, a first embodiment will be described. FIG. 1 is a diagram illustrating an example of a job scheduling method according to a first embodiment. FIG. 1 illustrates an information processing apparatus 10 that performs a job scheduling method. The information processing apparatus 10 may execute the job scheduling method by executing, for example, a job scheduling program in which the process procedure of the job scheduling method is described.

The information processing apparatus 10 is connected to, for example, an HPC (High Performance Computing) system 1. The HPC system 1 has calculation nodes 1a, 1b, 1c. . . . The HPC system 1 is executing a first job 2. At this time, one or more of the calculation nodes 1a, 1b, 1c, . .. are allocated to the first job 2. The information processing apparatus 10 performs scheduling for one or more second jobs including the first job 2, which are allocated to the calculation nodes 1a, 1b, 1c. . . . The information processing apparatus 10 includes a storage unit 11 and a processing unit 12 in order to implement the job scheduling method. The storage unit 11 is, for example, a memory or a storage device included in the information processing apparatus 10. The processing unit 12 is, for example, a processor or an arithmetic circuit included in the information processing apparatus 10.

The storage unit 11 stores determination information 11a. When the power consumption of each of fourth jobs 3a, 3b, . . . whose execution is completed, is predicted by using the other jobs of the fourth jobs 3a, 3b, . . . , the determination information 11a indicates a probability of a second prediction success for the matching status of parameters with the other job used for the prediction. For example, the determination information 11a includes a record in which the items of a job name, a user name, and a group name are “TRUE” and the item of the second prediction success probability is “95%”. In this case, when the power consumption of each of the fourth jobs 3a, 3b, . . . is predicted as jobs having the same job name, user name, and group name among the fourth jobs 3a, 3b, . . . , the determination information 11a indicates that the probability of successful prediction is 95%.

Further, the storage unit 11 stores job information related to a job before execution, a job under execution, and a job whose execution is completed. The job information includes, for example, parameter information at the time of job execution. In addition, the job information of the job under execution includes the time-series change in the power consumption of the job up to now. In addition, the job information of the job whose execution is completed includes the time-series change in the power consumption of the job from the start of execution to the end of execution.

The processing unit 12 determines the estimated power consumptions of the first job 2 under execution and a third job 4 before execution. In determining the estimated power consumption of the first job 2, the processing unit 12 first calculates first predicted power consumption which is obtained by predicting the power consumption of the first job 2 in a first period before the present, based on information before the first period. For example, the processing unit 12 calculates the time change of the power consumption of the first job 2 in the first period, as the first predicted power consumption, based on the time change of the power consumption of the first job 2 from the start of execution of the first job 2 to the start of the first period. The processing unit 12 calculates the first predicted power consumption, for example, by using a learned recurrent neural network (RNN) that adopts the time-series change of the power consumption up to a prediction target period, as an input, and the time-series change of the power consumption in the prediction target period, as an output.

Next, the processing unit 12 determines whether an error between the power consumption of the first job 2 in the first period and the first predicted power consumption is less than a threshold value. For example, when an error between the power consumption of the first job 2 and the first predicted power at each measurement point in the first period is less than the threshold value, the processing unit 12 determines that the error between the power consumption of the first job 2 in the first period and the first predicted power consumption is less than the threshold value. When the error between the power consumption of the first job 2 in the first period and the first predicted power consumption is less than the threshold value, the processing unit 12 calculates second predicted power consumption which is the power consumption predicted when the first job 2 is executed in a second period after the present.

For example, the processing unit 12 calculates the second predicted power consumption obtained by predicting the time change of the power consumption of the first job 2 in the second period based on the time change of the power consumption from the start of execution of the first job 2 to the start of the second period. Then, the processing unit 12 determines the estimated power consumption of the first job 2 in the second period, as the second predicted power consumption, at the time of scheduling. Further, the processing unit 12 may calculate power consumption, which is larger than the prediction of the time change of the power consumption of the first job 2 in the second period by a predetermined ratio, as the second predicted power consumption.

When the error between the power consumption of the first job 2 in the first period and the first predicted power consumption is equal to or larger than the threshold value, the processing unit 12 determines the estimated power consumption of the first job in the second period at the time of scheduling, as second power. The second power is determined based on, for example, the total rated power consumption of each of one or more first calculation nodes.

In determining the estimated power consumption of the third job 4, the processing unit 12 first calculates a first prediction success probability of the power consumption in the second period when the third job 4 is allocated to one or more second calculation nodes of the calculation nodes 1a, 1b, 1c. . . . For example, the processing unit 12 specifies a fifth job of the fourth jobs 3a, 3b, . . . for predicting the power consumption of the third job 4. The fifth job is, for example, one of a predetermined number of jobs having the highest similarity with the third job 4, which is calculated by a predetermined calculation formula, among the fourth jobs 3a, 3b. . . . Then, the processing unit 12 calculates the second prediction success probability corresponding to the matching status of parameters of the third job 4 and the fifth job, which is specified based on the determination information 11a, as the first prediction success probability.

Next, the processing unit 12 determines whether the first prediction success probability is equal to or larger than a predetermined value. When the first prediction success probability is equal to or larger than the predetermined value, the processing unit 12 calculates third predicted power consumption which is the power consumption predicted when the third job 4 is executed in the second period. For example, the processing unit 12 calculates the third predicted power consumption, which is the power consumption predicted when the third job 4 is executed in the second period, based on the power consumption when the fifth job is executed in the past. For example, the processing unit 12 sets the time-series change of the power consumption from the start when the fifth job is executed in the past to the length of the second period to be increased by a predetermined ratio, as the third predicted power consumption. Then, the processing unit 12 determines the estimated power consumption of the third job 4 in the second period, as the third predicted power consumption at the time of scheduling. When the first prediction success probability is smaller than the predetermined value, the processing unit 12 sets the estimated power consumption of the third job 4 in the second period at the time of scheduling to third power which is determined based on the total rated power consumption of one or more second calculation nodes.

Then, the processing unit 12 performs scheduling based on the estimated power consumptions of the first job 2 and the third job 4. In the scheduling, the processing unit 12 allocates one or more second jobs to the calculation nodes 1a, 1b, 1c, . . . so that the total estimated power consumption of each of the one or more second jobs in the second period does not exceed predetermined first power. The first power is determined based on, for example, the total rated power consumption of the calculation nodes 1a, 1b, 1c. . . .

As an example, in the HPC system 1, it is assumed that jobs other than the first job 2 are not executed and the third job 4 of the jobs before execution has the highest priority allocated to the calculation nodes 1a, 1b, 1c. . . . Then, the processing unit 12 calculates the estimated power consumption of the first job 2 in the second period and the estimated power consumption of the third job 4 in the second period. When the total of the estimated power consumption of the first job 2 in the second period and the estimated power consumption of the third job 4 in the second period is equal to or less than the first power, the processing unit 12 allocates the third job 4 to one or more second calculation nodes. When the total of the estimated power consumption of the first job 2 in the second period and the estimated power consumption of the third job 4 in the second period exceeds the first power, the processing unit 12 does not allocate the third job 4 to the calculation nodes.

According to such an information processing apparatus 10, the processing unit 12 calculates the first predicted power consumption of the first job 2 in the first period and determines the estimated power consumption of the first job 2 in scheduling according to the error between the first predicted power consumption and the power consumption of the first job in the first period. The processing unit 12 determines the estimated power consumption of the first job 2 as the second predicted power consumption when the error is smaller than the threshold value, and determines the estimated power consumption of the first job 2 as the predetermined second power when the error is equal to or larger than the threshold value.

Here, in a scheduling where the power consumption of the job does not exceed the predetermined power, the power consumption of each job is often estimated to be relatively high (e.g., it is estimated to be the total rated power consumption of the calculation nodes used). The information processing apparatus 10 determines the estimated power consumption as the predicted power consumption for a job for which the power consumption prediction is likely to succeed. As a result, the information processing apparatus 10 may improve the power efficiency of the HPC system 1 by allowing many jobs to be allocated to the calculation nodes in the scheduling where the power consumption does not exceed the first power.

Further, the first power is determined based on the total rated power consumption of the calculation nodes 1a, 1b, 1c. . . . As a result, the information processing apparatus 10 may improve the power efficiency of the HPC system 1 in the scheduling where the power consumption of the job does not exceed the upper limit of the power consumption of the HPC system 1.

Further, the second power is determined based on the total rated power consumption of each of one or more first calculation nodes. As a result, the information processing apparatus 10 may set power higher than the actual power consumption, as the estimated power consumption for a job for which the prediction is not likely to succeed.

Further, the processing unit 12 calculates the first prediction success probability of the power consumption in the second period when the third job 4 is executed, and determines the estimated power consumption of the third job 4 in scheduling according to the first prediction success probability. The processing unit 12 determines the estimated power consumption of the third job 4 as the third predicted power consumption when the first prediction success probability is equal to or larger than the predetermined value, and determines the estimated power consumption of the third job 4 as predetermined third power when the first prediction success probability is smaller than the predetermined value. As a result, even for jobs before execution, the information processing apparatus 10 may use the estimated power consumption as the predicted power consumption for a job for which the power consumption prediction is likely to succeed.

Further, the processing unit 12 calculates the first predicted power consumption and the second predicted power consumption based on the time change of the power consumption of the first job 2 up to the present. As a result, the number of pieces of data used for prediction increases as the execution of the first job 2 progresses. Therefore, the information processing apparatus 10 may improve the prediction accuracy of the power consumption of a job as the execution time of the job increases.

Further, the processing unit 12 predicts the power consumption of the third job 4 based on the determination information 11a and the fifth job among the fourth jobs 3a, 3b. . . . As a result, the information processing apparatus 10 may accurately predict the power consumption of a job before execution.

Further, the processing unit 12 may determine the priority allocated to the calculation nodes 1a, 1b, 1c, . . . at the time of scheduling each of the plurality of third jobs 4. For example, the processing unit 12 calculates the ratio of the usage amount of the plurality of calculation nodes of a third job 4 in which the first prediction success probability is equal to or larger than a predetermined value, among the plurality of third jobs 4, and the usage amount of the plurality of calculation nodes of a third job 4 in which the first prediction success probability is smaller than the predetermined value, among the plurality of third jobs 4. Then, the processing unit 12 may determine the priority of each of the plurality of third jobs 4 based on the calculated ratio. As a result, the information processing apparatus 10 may cause the HPC system 1 to execute a job having a higher possibility of successful prediction and a job having a lower possibility of successful prediction at a constant ratio.

### Second Embodiment

Next, a second embodiment will be described. The second embodiment involves dynamically predicting the power consumption of a job and performing a scheduling based on the predicted power consumption of the job.

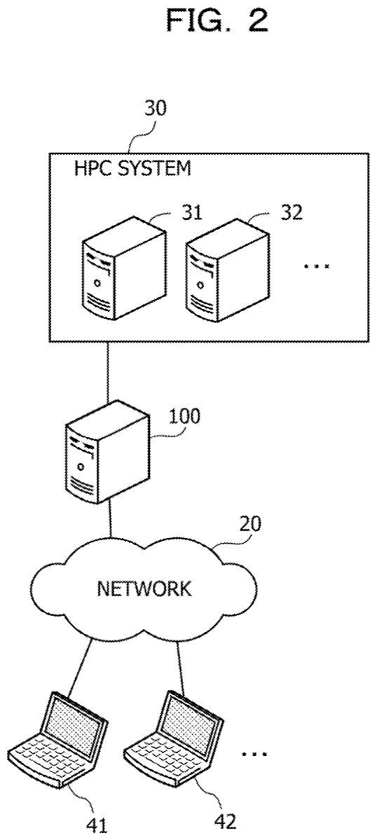

FIG. 2 is a diagram illustrating a system configuration example of the second embodiment. An HPC system 30 has a plurality of calculation nodes 31, 32. . . . The calculation nodes 31, 32, . . . are computers that execute input jobs.

The calculation nodes 31, 32, . . . in the HPC system 30 are connected to an HPC operation management server 100. The HPC operation management server 100 is a computer that manages the operation of the HPC system 30. For example, the HPC operation management server 100 monitors the time-series change of the power consumption of the calculation nodes 31, 32, . . . during job execution. Further, the HPC operation management server 100 predicts power consumption patterns of a job waiting to be executed and a job under execution, and performs a job scheduling so that the power consumption of these jobs does not exceed the rated power consumption of the entire HPC system 30. Then, the HPC operation management server 100 instructs the calculation nodes 31, 32, . . . to execute the jobs according to a created job execution schedule.

The HPC operation management server 100 is connected to terminal devices 41, 42, . . . via a network 20. Each of the terminal devices 41, 42, . . . is a computer used by a user who wishes to execute a job by the HPC system 30. Each of the terminal devices 41, 42, . . . generates job information indicating the contents of the job to be executed by the HPC system 30 based on an input from the user, and transmits a job input request including the generated job information to the HPC operation management server 100. The job information includes status information such as an application program name used in a job.

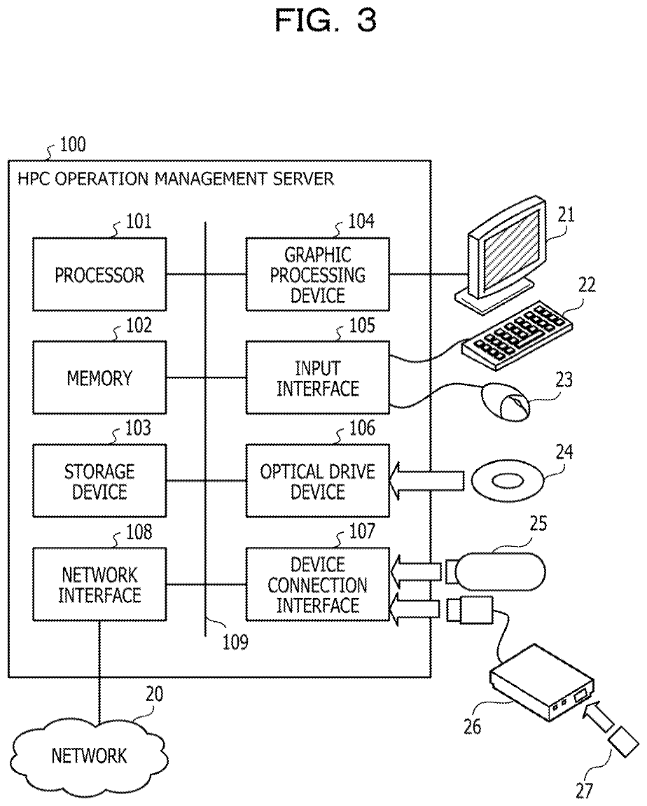

FIG. 3 is a diagram illustrating a configuration example of hardware of the HPC operation management server. The entire HPC operation management server 100 is controlled by the processor 101. A memory 102 and a plurality of peripheral devices are connected to the processor 101 via a bus 109. The processor 101 may be a multiprocessor. The processor 101 is, for example, a central processing unit (CPU), a micro processing unit (MPU), or a digital signal processor (DSP). At least a part of the functions which are implemented by the processor 101 executing a program may be implemented by an electronic circuit such as an application specific integrated circuit (ASIC) or a programmable logic device (PLD).

The memory 102 is used as a main storage device of the HPC operation management server 100. At least a part of an operating system (OS) program and an application program to be executed by the processor 101 may be temporarily stored in the memory 102. Further, various data used for processing by the processor 101 are stored in the memory 102. As for the memory 102, for example, a volatile semiconductor memory device such as a random access memory (RAM) may be used.

The peripheral devices connected to the bus 109 include a storage device 103, a graphic processing device 104, an input interface 105, an optical drive device 106, a device connection interface 107, and a network interface 108.

The storage device 103 electrically or magnetically writes and reads data in and from a built-in recording medium. The storage device 103 is used as an auxiliary storage device for a computer. The storage device 103 stores an OS program, an application program, and various data. As for the storage device 103, for example, a hard disk drive (HDD) or a solid state drive (SSD) may be used.

A monitor 21 is connected to the graphic processing device 104. The graphic processing device 104 causes an image to be displayed on a screen of the monitor 21 according to an instruction from the processor 101. An example of the monitor 21 may include an organic electro luminescence (EL) display device or a liquid crystal display device.

A keyboard 22 and a mouse 23 are connected to the input interface 105. The input interface 105 transmits signals, which are sent from the keyboard 22 and the mouse 23, to the processor 101. The mouse 23 is an example of a pointing device, and other pointing devices may also be used as the mouse 23. Other pointing devices include a touch panel, a tablet, a touch pad, a trackball, and the like.

The optical drive device 106 reads data recorded on an optical disk 24 by using a laser beam or the like. The optical disk 24 is a portable recording medium on which the data is recorded so that they may be read by reflection of light. The optical disk 24 includes a digital versatile disk (DVD), a DVD-RAM, a compact disk read only memory (CD-ROM), a CD-R (Recordable)/RW (ReWritable), or the like.

The device connection interface 107 is a communication interface for connecting the peripheral devices to the HPC operation management server 100. For example, a memory device 25 and a memory reader/writer 26 may be connected to the device connection interface 107. The memory device 25 is a recording medium equipped with a communication function with the device connection interface 107. The memory reader/writer 26 is a device that writes data in a memory card 27 or reads data from the memory card 27. The memory card 27 is a card-type recording medium.

The network interface 108 is connected to the network 20. The network interface 108 exchanges data with another computer or communication device via the network 20.

The HPC operation management server 100 may implement the processing function of the second embodiment by the above-described hardware configuration. In addition, the calculation nodes 31, 32, . . . and the terminal devices 41, 42, . . . may also be implemented by the same hardware as the HPC operation management server 100 illustrated in FIG. 3. Further, the information processing apparatus 10 illustrated in the first embodiment may also be implemented by the same hardware as the HPC operation management server 100 illustrated in FIG. 3.

The HPC operation management server 100 implements the processing function of the second embodiment, for example, by executing a program recorded on a computer-readable recording medium. The program that describes the processing contents to be executed by the HPC operation management server 100 may be recorded on various recording media. For example, the program to be executed by the HPC operation management server 100 may be stored in the storage device 103. The processor 101 loads and executes at least a part of the program in the storage device 103 into the memory 102. Further, the program to be executed by the HPC operation management server 100 may be recorded on a portable recording medium such as the optical disk 24, the memory device 25, or the memory card 27. The program stored in the portable recording medium may be executed after being installed in the storage device 103, for example, under control of the processor 101. Also, the processor 101 may read and execute the program directly from the portable recording medium.

In the system illustrated in FIG. 2, the HPC operation management server 100 performs an appropriate power management of the HPC system 30. For example, the HPC operation management server 100 performs scheduling of a job executed by the HPC system 30 so that the power consumption of the job does not exceed the upper limit of the power consumption of the HPC system 30 (the rated power consumption of the entire HPC system 30). Each of the calculation nodes 31, 32, . . . has the rated power consumption, and in the second embodiment, it is assumed that the total rated power consumption of all the calculation nodes is larger than the rated power consumption of the entire HPC system 30. Further, it is assumed that the rated power consumption of each of the calculation nodes 31, 32, . . . is the same.

Here, as for the scheduling where the power consumption of the job does not exceed the rated power consumption of the HPC system 30, a method of performing scheduling with the estimation that the power consumption of each job is the total rated power consumption of the calculation nodes that execute the job (the maximum power consumption of the job) may be considered. Then, since the actual power consumption of the job does not exceed the rated power consumption of the calculation nodes used, the actual power consumption of the entire HPC system 30 does not exceed the rated power consumption of the HPC system 30. However, when a difference between the actual power consumption of the job and the maximum power consumption of the job is relatively large, the power efficiency of the HPC system 30 decreases.

Therefore, the HPC operation management server 100 determines whether the future time-series change of the power consumption of a job before or under execution may be predicted, and performs scheduling for a job that may predict the time-series change of power, based on the predicted time-series change of power. The time-series change of the power consumption is represented by, for example, a power waveform. In the following, a method of predicting a power waveform when a newly input job is executed and the future power waveform of a job under execution will be described.

In predicting the power waveform when the newly input job is executed, for example, the HPC operation management server 100 determines the power waveform of the newly input job from among power waveforms of jobs similar to the newly input job, among jobs whose execution is completed. Therefore, for example, the HPC operation management server 100 first specifies the jobs similar to the newly input job. The similarity between jobs may be expressed by the similarity of information indicating the status of a job (hereinafter, referred to as job status information) such as the user ID of a user who inputs a job execution request, the type of a job, the degree of parallelism at the time of job execution (how many calculation nodes need to be executed in parallel), and the like.

The job status information of each job is a document including a plurality of sets of item names of items related to the job status and the values of the items. An example of a technique that may be used to calculate the similarity between documents may include a latent Dirichlet allocation (LDA) estimation model. For example, the HPC operation management server 100 calculates a topic distribution represented by the job status information of each job by using the LDA estimation model, and sets the similarity of the topic distribution between jobs as the job similarity.

The LDA estimation model is a type of topic model. The topic model is a model that assumes that a document is probabilistically generated from a plurality of latent topics (each word in the document appears according to a probability distribution of a topic). Using the LDA estimation model, it is possible to estimate the mixing ratio of topics represented in each document from a set of document data to be analyzed.

A Dirichlet distribution, which is a conjugated prior distribution of a polynomial distribution, is used to generate the topic distribution of each document. The Dirichlet distribution is expressed by the following equation.

$$Dir ( x \text{\textbar} a ) = \frac{Γ ( {\sum }_{k - 1}^{K} {a}_{k} )}{{\prod }_{k - 1}^{K} Γ ( {a}_{k} )} {\prod }_{k - 1}^{K} {x}_{k}^{{a}_{k} - 1} \\ x = \{ {x}_{1} , … , {x}_{K} \} , \\ 0 \leq {x}_{k} \leq 1 , \\ {\sum }_{k - 1}^{K} {x}_{k} = 1 \\ a = \{ {a}_{1} , … , {a}_{K} \} , \\ {a}_{k} > 0 \qquad ( 1 )$$

The equation (1) represents the probability that a vector x occurs, based on a vector a which is a parameter. The symbol “r” refers to a gamma function. The vector x is a real number vector indicating a random variable. The symbol “K” refers to the number of topics. The symbol “k” refers to a topic index.

The HPC operation management server 100 examines what type of word appears in each sentence (job status information) from a job status information group which is a training data set. Then, the HPC operation management server 100 counts which words frequently appear in the same sentence, groups words that have a high probability of appearing in the same sentence, and sets the grouped words as a topic.

Specifically, the HPC operation management server 100 calculates the probability for each document and each word by the following equation (2).

$$P ( {z}_{d , n} = k \vert {w}_{d , n} = v , {w}^{\backslash d , n} , {z}^{\backslash d , n} , α , β ) ∝ \frac{{N}_{k , v}^{\backslash d , n} + β}{{N}_{k}^{\backslash d , n} + β V} ( {N}_{d , k}^{\backslash d , n} + α ) \qquad ( 2 )$$

The symbol “N” refers to the total number of words in a document set. The symbol “V” refers to the total number of vocabularies (the number of types of words contained in the entire document set). The symbol “d” refers to a document index. The symbol “n” refers to a word index. The symbol “v” refers to a vocabulary index. The symbol “w” refers to a word. The symbol “z” refers to a topic. Backslash indicates a difference from a set. The symbol “β” refers to a parameter of word distribution. The equation (2) is a sampling equation for a topic z_{d,n} for a word w_{d,n} in a document d.

The HPC operation management server 100 uses a combination of words with a high probability (e.g., a predetermined value or more) obtained by the equation (2), as a topic. That is, as a result of learning using the LDA estimation model, the HPC operation management server 100 obtains a set of words belonging to a topic.

The HPC operation management server 100 calculates a topic distribution of the job status information based on a topic to which a word included in the job status information of each job belongs. The HPC operation management server 100 may compare a topic distribution generated based on the job status information of each job between jobs to calculate the similarity between the jobs.

For example, the HPC operation management server 100 estimates jobs similar to the newly input job based on the similarity of the topic distribution. For example, the HPC operation management server 100 calculates the similarity of jobs by calculating the cosine similarity between topic distributions.

The HPC operation management server 100 calculates the topic distribution for each job. The topic distribution may be represented by a vector by adopting its topic index as an element number and its occurrence frequency value of the corresponding topic in a document (job status information) as an element. The HPC operation management server 100 calculates the cosine similarity between a vector indicating the topic distribution of the newly input job and a vector indicating the topic distribution of a job whose execution is completed, and uses this as the similarity between jobs. As a result, the more common topics are included in the topic distributions of jobs to be compared, the higher the similarity.

Further, the HPC operation management server 100 may calculate the similarity between each topic included in the topic distribution of the newly input job and each topic included in the topic distribution of a job whose execution is completed, and determine the similarity between job distributions based on the calculated similarity between topics. For example, the HPC operation management server 100 uses the total similarity between topics included in topic distributions to be compared, as the topic distribution similarity.

The HPC operation management server 100 may measure the similarity S_{kk′} between topics by, for example, a vector space method. The vector space method is defined by the cosine of an occurrence frequency vector of a vocabulary for each topic in a vocabulary space V. The similarity between the k-th topic and the k′-th topic is expressed by the following equation.

$${S}_{{kk}^{′}} = \frac{{n}_{k} \cdot {n}_{{k}^{′}}}{\vert {n}_{k} \vert \vert {n}_{{k}^{′}} \vert} \qquad ( 3 )$$

The symbol “nₖ” refers to the appearance frequency vector of the k-th topic. The symbol “nₖ” refers to the occurrence frequency vector nₖ of the k′-th topic.

In this way, the topic distribution of each job may be calculated using the LDA estimation model, and the job similarity may be calculated by the similarity between topic distributions. Then, the HPC operation management server 100 may use the power waveforms of a predetermined number of jobs similar to a newly input job among jobs whose execution is already completed, as power waveform candidates for the prediction of the newly input job.

In the prediction of the future power waveform of a job under execution, for example, a prediction model learned by an RNN is used.

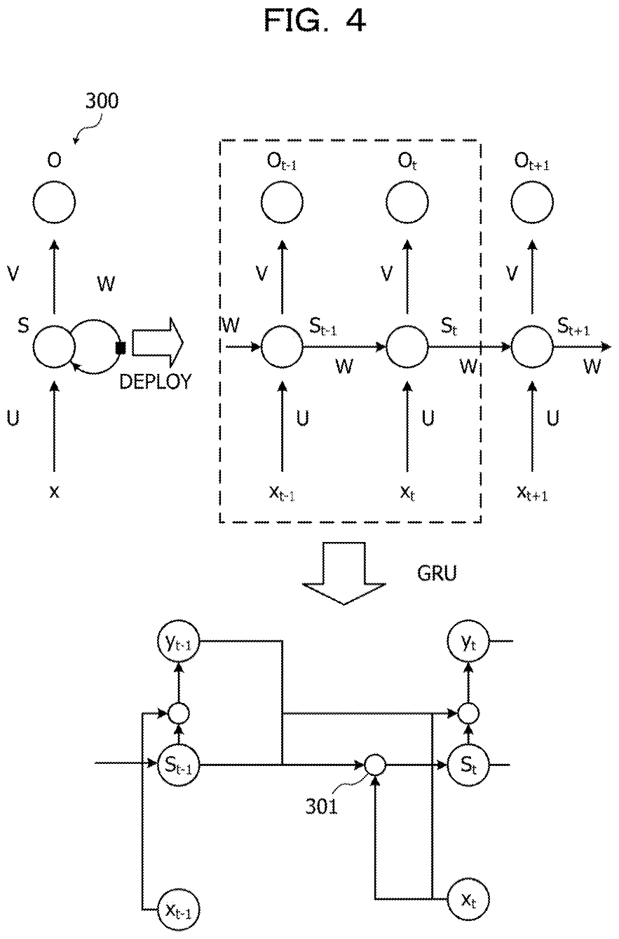

FIG. 4 is a diagram for explaining an RNN. The RNN 300 is a type of neural network and is used for learning of time-series data. In the RNN, the contents of a hidden layer at time t are treated as an input at the next time t+1. The RNN 300 includes a long short-term memory network (LSTM) and a gated recurrent unit (GRU).

The LSTM introduces a gate mechanism to store the distant past. Therefore, the LSTM is useful for a problem that may not be predicted without referring to past information. The GRU is an improved version of the RSTM. The GRU is a simplified structure of the LSTM, which is a combination of a forgetting gate and an input gate, as a single update gate 301.

In the update gate 301, it is possible to set the degree on how far back information is used. In the RNN 300, the degree on how far back information is used is set as a delay time. The delay time is a hyper parameter that determines how far past information is used for performing learning/prediction for a measurement point to be predicted.

When the time-series change of the job power consumption by the RNN 300 is predicted, a prediction model may be created using a measurement result of the power consumption of a job whose execution is already completed. The HPC operation management server 100 creates a model for each section of the elapsed time from the start of job execution. Then, the HPC operation management server 100 inputs the power waveform from the start of job execution to a prediction target section into a model corresponding to the prediction target section of a job under execution, and predicts a power waveform in the prediction target section.

Hereinafter, a job scheduling method of the HPC system 30 by the HPC operation management server 100 will be described in detail.

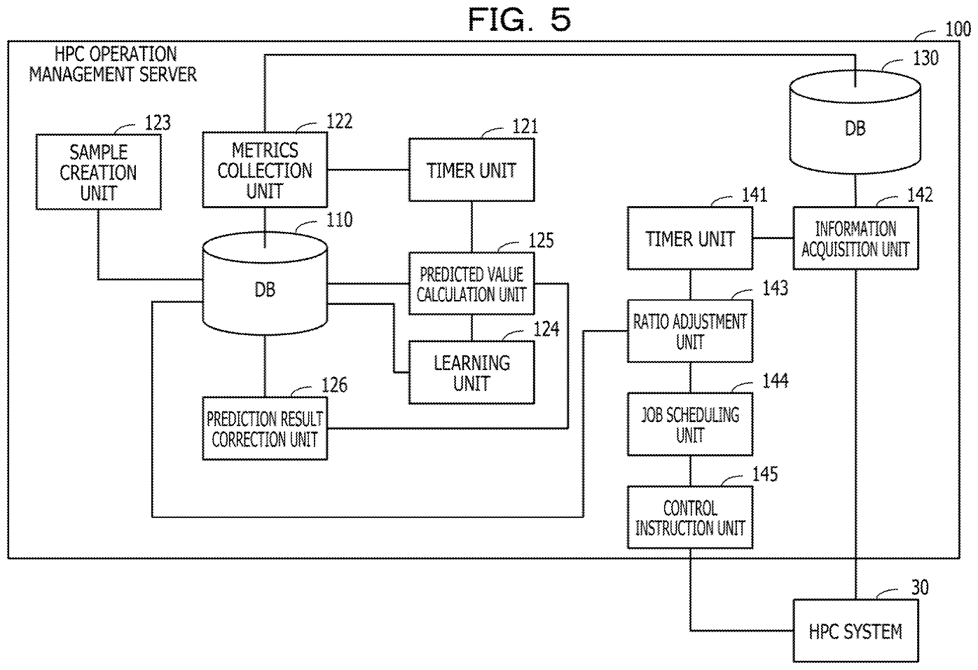

FIG. 5 is a block diagram illustrating the functions of the HPC operation management server. The HPC operation management server 100 includes a DB 110, a timer unit 121, a metrics collection unit 122, a sample creation unit 123, a learning unit 124, a predicted value calculation unit 125, and a prediction result correction unit 126. The HPC operation management server 100 also includes a DB 130, a timer unit 141, an information acquisition unit 142, a ratio adjustment unit 143, a job scheduling unit 144, and a control instruction unit 145.

The DB 130 stores job status information indicating the status of a job to be executed and job power consumption information indicating the time-series change of the power consumption of an executed job.

The timer unit 141 manages the timing of collecting power consumption information for each job from the HPC system 30 and the timing of generating a queue to be used for scheduling. For example, the timer unit 141 instructs the information acquisition unit 142 to collect the job power consumption information at regular intervals. Further, the timer unit 141 instructs the ratio adjustment unit 143 to generate the queue to be used for scheduling at regular intervals.

The information acquisition unit 142 acquires time-series power data of a job under execution or a job whose execution is completed in the HPC system 30 from the HPC system 30 in response to an instruction from the timer unit 141. The information acquisition unit 142 stores the acquired power consumption information in the DB 130.

Further, the HPC system 30 has a function of measuring power for each job. For example, each of the calculation node 31, 32, . . . in the HPC system 30 is equipped with a device for measuring power consumption, and a difference between the power consumption when a job is not being executed and the power consumption while the job is being executed may be set as the power consumption of the job. Further, the calculation nodes 31, 32, . . . may predict the power consumption of jobs based on information of a temperature sensor and the like. For example, the calculation nodes 31, 32, . . . collect a CPU temperature and a system board (SB) exhaust temperature by the temperature sensor. The calculation nodes 31, 32, . . . first calculate a CPU temperature change (T_{cpu}) and an SB exhaust temperature change (Tₐᵢᵣ) based on the collected temperature data.

The CPU temperature change (T_{cpu}) may be calculated by the following equation.

CPU temperature change(T_{cpu})=CPU temperature−water-cooled input temperature (4)

In addition, the SB exhaust temperature change (Tₐᵢᵣ) may be calculated by the following equation.

SB exhaust temperature change(Tₐᵢᵣ)=SB exhaust temperature−rack intake temperature (5)

The calculation nodes 31, 32, calculate the CPU power consumption from the CPU temperature change (e.g., the CPU power consumption=1.02·T_{cpu}). Further, the calculation nodes 31, 32, calculate the memory power consumption from the SB exhaust temperature (e.g., the memory power consumption=0.254·Tₐᵢᵣ). Further, it is assumed that the power consumption of an interconnect controller (ICC) is a constant value for the calculation nodes 31, 32, . . . (e.g., the ICC power consumption=8.36). Then, the calculation nodes 31, 32, . . . predict job power P by the following equation.

P=1.02·T_{cpu}+0.254·Tₐᵢᵣ+8.36 (6)

The ratio adjustment unit 143 generates a queue indicating the execution priority of a job before execution. For example, the ratio adjustment unit 143 classifies jobs into a job having a higher probability of successful power consumption prediction and a job having a lower probability of successful power consumption prediction. Then, the ratio adjustment unit 143 inputs jobs into a queue so that the ratio of the usage amount (e.g., the number of requested nodes x the maximum execution time) of a calculation node of the job having a higher probability of successful power consumption prediction and the usage amount of a calculation node of the job having a lower probability of successful power consumption prediction is constant.

The job scheduling unit 144 schedules jobs input into the queue generated by the ratio adjustment unit 143 at the timing when job execution starts or ends. For example, the job scheduling unit 144 selects the jobs input in the queue in order of priority, and executes the next process for the selected jobs. The job scheduling unit 144 calculates the total of the future estimated power consumption of all the jobs under execution and the future estimated power consumption of the jobs selected from the queue. Then, when the calculated total estimated power consumption is less than the rated power consumption of the entire HPC system 30, the job scheduling unit 144 schedules the jobs selected from the queue. The control instruction unit 145 instructs the HPC system 30 to execute a job according to the job execution schedule by the job scheduling unit 144.

The DB 110 stores information to be used for predicting a power consumption pattern for each job. The timer unit 121 manages the acquisition timing of the time-series power data of the executed job. For example, the timer unit 121 instructs the metrics collection unit 122 to collect the information from the DB 130 at regular intervals. Further, when the job execution is started, the timer unit 121 instructs the predicted value calculation unit 125 to predict the power consumption of the corresponding job at regular intervals.

The metrics collection unit 122 collects the information from the DB 130 in response to an instruction from the timer unit 121. For example, the metrics collection unit 122 acquires job status information of a job waiting to be executed and a job whose execution is completed, and time-series power data indicating a power consumption pattern of the job whose execution is completed, from the DB 130. The metrics collection unit 122 stores the acquired information in the DB 110.

The sample creation unit 123 creates sample data to be used for generating a prediction model for estimating power consumption, based on the time-series power data stored in the DB 110. For example, the sample creation unit 123 creates a learning data set for each prediction target period, with each of a plurality of time zones obtained by dividing the elapsed time from the start of job execution, as a prediction target period. Then, the sample creation unit 123 stores the created learning data sets in the DB 110, as sample data.

The learning unit 124 generates information for estimating the power consumption of a job before execution and information for estimating the power consumption of a job under execution. The learning unit 124 generates, as the information for estimating the power consumption of the job before execution, determination information indicating a prediction success probability when the power consumption of the job before execution is predicted by a similar job executed in the past. First, the learning unit 124 generates an LDA estimation model based on the job information. For example, the learning unit 124 analyzes words included in the job status information of a plurality of jobs and classifies the words into groups for each topic. The learning unit 124 stores the learning result in the DB 110.

Next, the learning unit 124 determines whether the power consumption of each of jobs executed in the past may be predicted by the power consumption of the most similar job specified by the LDA estimation model among the other jobs executed in the past. Then, the learning unit 124 generates determination information indicating a prediction success probability for the matching status of parameters with the job used for the prediction, and stores the generated determination information in the DB 110.

The learning unit 124 uses a neural network as information for estimating the power consumption of a job under execution to generate a prediction model for predicting the later power consumption from the past power consumption information of the job. The learning unit 124 generates a prediction model by an RNN, for example, for each prediction target period, using the data set of the corresponding period.

The predicted value calculation unit 125 uses a prediction model to predict the time-series change of the power consumption after the job under execution at the timing of being instructed by the timer unit 121. For example, the predicted value calculation unit 125 uses the prediction model of a period corresponding to the execution time of the current job to predict the power consumption of a group to which the job to be predicted for power consumption belongs.

The prediction result correction unit 126 determines the estimated power consumption of the job before execution and the estimated power consumption of the job under execution. In determining the estimated power consumption of the job before execution, the prediction result correction unit 126 uses the LDA estimation model to specify a predetermined number of jobs similar to the job to be predicted, from the jobs executed in the past. The prediction result correction unit 126 specifies the prediction success probability of the power of a prediction target job by the power consumption of each of the specified predetermined number of jobs, based on the parameter matching status with the prediction target job of each of the specified predetermined number of jobs and the determination information. Then, the prediction result correction unit 126 determines the power consumption of a job whose prediction success probability is equal to or larger than a predetermined value (e.g., 95%), as the estimated power consumption of the prediction target job. When there is no job whose prediction success probability is equal to or larger than the predetermined value, the prediction result correction unit 126 determines the total rated power consumption (maximum power consumption of a job) of calculation nodes that execute the prediction target job, as the estimated power consumption of the prediction target job.

In determining the estimated power consumption of the job under execution, the prediction result correction unit 126 calculates an error between the power consumption of the corresponding period, which is predicted by the predicted value calculation unit 125 using the prediction model of the period before the present, and the actual power consumption of the corresponding period. When the error is smaller than a threshold value, the prediction result correction unit 126 determines the later power consumption of the prediction target job, which is predicted by the predicted value calculation unit 125, as the estimated power consumption of the prediction target job. When the error is equal to or larger than the threshold value, the prediction result correction unit 126 determines the maximum power consumption of the prediction target job as the estimated power consumption of the prediction target job.

A line connecting between elements illustrated in FIG. 5 indicates a part of a communication path, and a communication path other than the illustrated communication path may be set. Further, the function of each element illustrated in FIG. 5 may be implemented, for example, by causing a computer to execute a program module corresponding to the element.

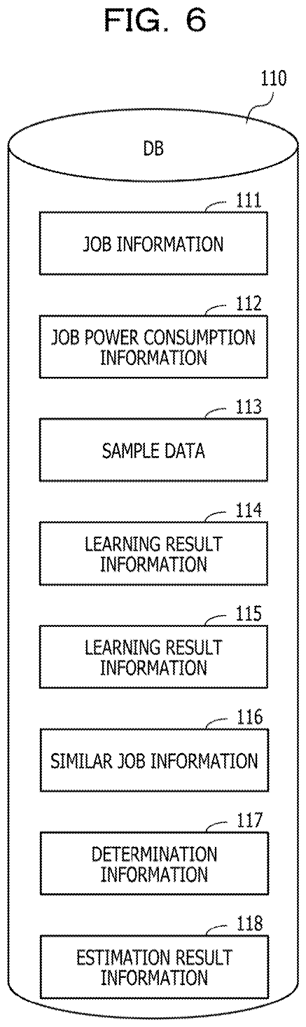

FIG. 6 is a diagram illustrating an example of information stored in a database. In the example of FIG. 6, the DB 110 stores job information 111, job power consumption information 112, sample data 113, learning result information 114 and 115, similar job information 116, determination information 117, and estimation result information 118.

The job information 111 is job status information such as a job name for each job. The job power consumption information 112 is information on the time-series power consumption of a job under execution or a job whose execution is completed. The sample data 113 is time-series power data which is extracted from the job power consumption information 112 and used to generate a prediction model for each prediction target period. The learning result information 114 is information indicating the learning result of the prediction model. The learning result information 115 is information indicating the learning result by LDA. The similar job information 116 is information indicating a job similar to a job before execution. The determination information 117 is information used for specifying the success probability of the power consumption prediction of a job before execution. The estimation result information 118 is information indicating the estimation result of the power consumption in a predetermined period a job before execution or a job under execution.

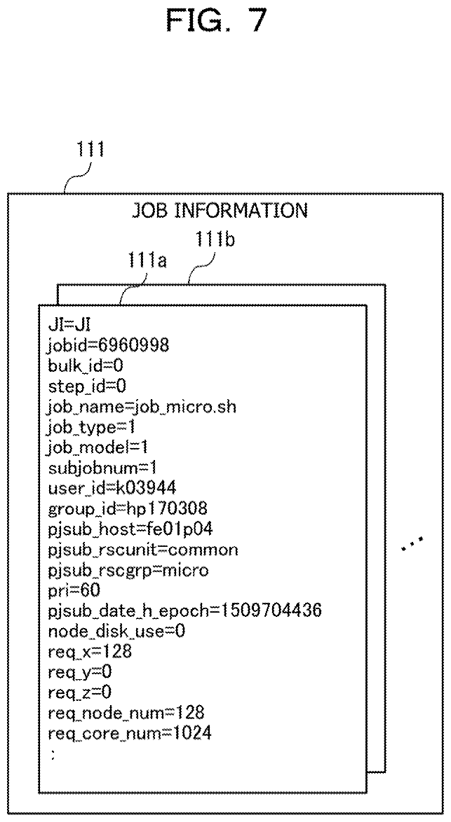

FIG. 7 is a diagram illustrating an example of the job information. The job information 111 includes, for example, job status information 111a, 111b, . . . , for each job. The job status information 111a, 111b, . . . includes various types of information related to job execution, such as a job ID, a job name, an application name, a user name of a user requesting the job execution, and a group ID of a group to which the user belongs.

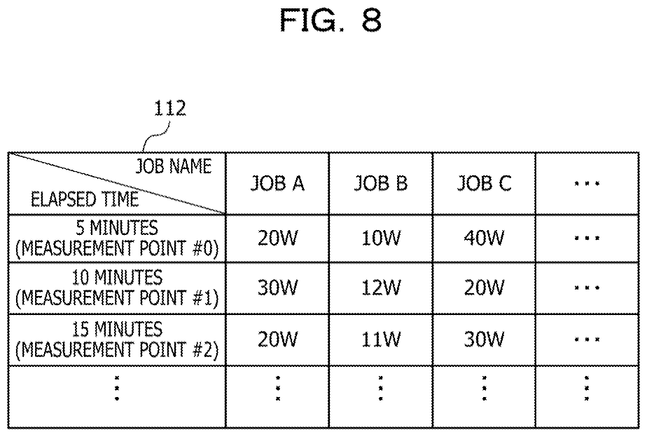

FIG. 8 is a diagram illustrating an example of the job power consumption information. The job power consumption information 112 is, for example, a data table in which the elapsed time from the start of job execution is set in a row label and a job name is set in a column label. At an intersection of a row and a column, the power consumption of a similar job for prediction at the point of time when only time illustrated in the row from the start of execution elapses is set when a job illustrated in the column is executed. In the example of FIG. 8, the elapsed time includes a measurement point number corresponding to the elapsed time.

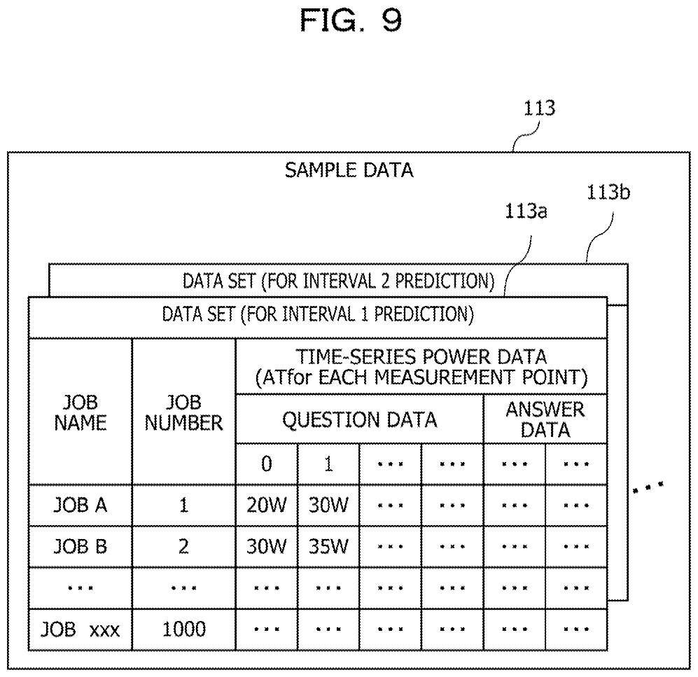

FIG. 9 is a diagram illustrating an example of the sample data. The sample data 113 includes a plurality of data sets 113a, 113b. . . . For example, the sample creation unit 123 assigns identifiers such as “Interval 0”, “Interval 1”, “Interval 2”, and so on in the order of earlier time for periods obtained by dividing the elapsed time from the start of job execution. At this time, the period of “Interval 0” is excluded from a prediction target period because there is no time-series power data before that period. Therefore, the sample creation unit 123 sets periods after “Interval 1” as prediction target periods. Then, the sample creation unit 123 creates the data sets 113a, 113b, . . . for each prediction target period.

For example, the data set 113a includes time-series power data to be used to generate a prediction model for the prediction target period of “Interval 1”. In the data set 113a, time-series power data of similar jobs for prediction is set in association with a set of a job name of an executed job and a job number of the job. In the time-series power data column, a power value measured at a measurement point is set in association with a measurement point number of the power.

The time-series power data included in the data set 113a is divided into question data and answer data. The question data includes a power value measured prior to the prediction target period of the data set 113a. The answer data includes a power value measured within the prediction target period of the data set 113a. Similar to the data set 113a, the other data sets 113b, . . . also include time-series power data to be used to generate a prediction model for each prediction target period.

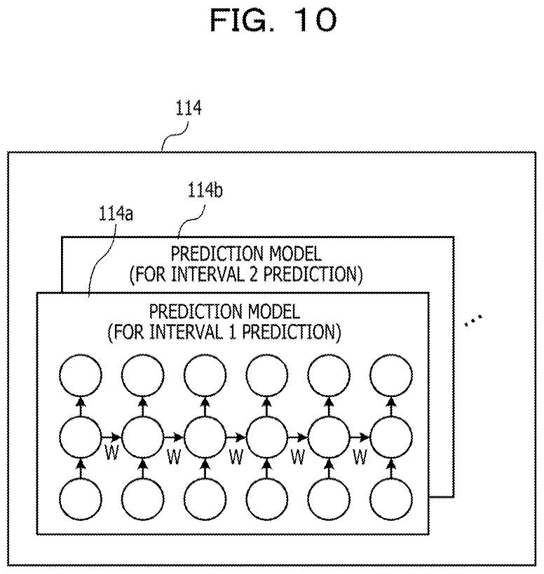

FIG. 10 is a diagram illustrating an example of the learning result information to be used to predict the power consumption of a job under execution. The learning result information 114 includes, for example, prediction models 114a, 114b, . . . for each group. For example, the prediction model 114a is a prediction model of a neural network (e.g., an RNN) that predicts the power consumption of each of 1 point ahead (5 minutes ahead) to 6 points ahead at the prediction points set at unit time (5 minutes) intervals. Learning in the neural network is to find an appropriate value of weight for data input to a unit corresponding to a neuron. For example, a structure of the RNN and a learned weight value are set in the learning result.

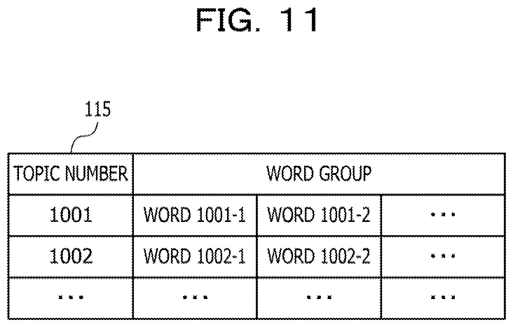

FIG. 11 is a diagram illustrating an example of the learning result information to be used to predict the power consumption of a job before execution. The learning result information 115 is a learning result by the LDA estimation model. In the learning result information 115, words belonging to a topic are registered in association with a topic number indicating the topic.

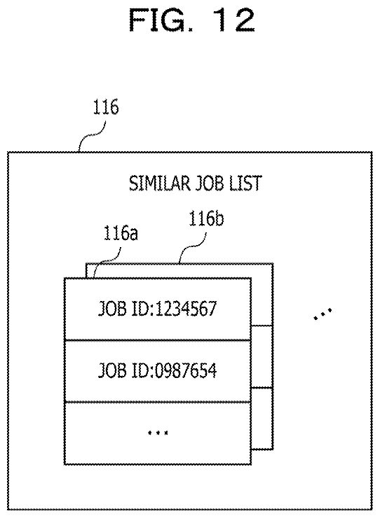

FIG. 12 is a diagram illustrating an example of the similar job information. For example, the similar job information 116 includes similar job lists 116a, 116b, . . . for each job before execution, which are determined based on the learning result information 115. The similar job lists 116a, 116b, . . . represent job IDs of a predetermined number of jobs similar to the jobs before execution, which are determined based on the learning result information 115 of the LDA estimation model.

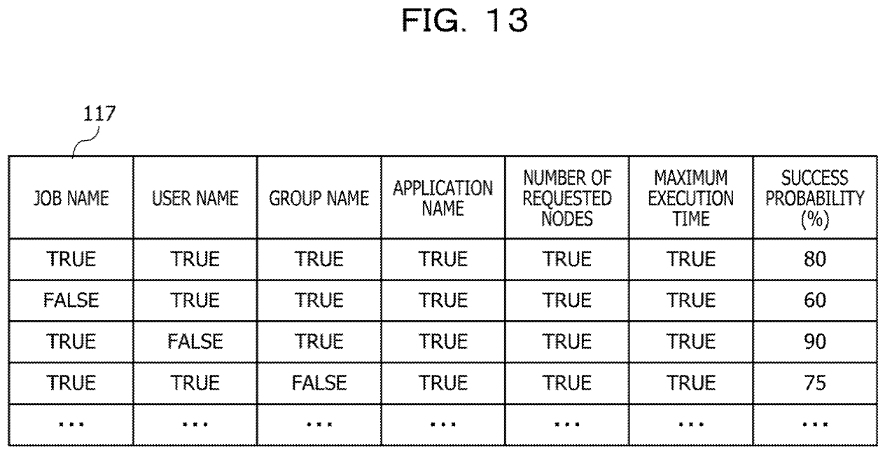

FIG. 13 is a diagram illustrating an example of the determination information. Whether each of a plurality of parameters matches (parameter matching status) is set in the determination information 117. The plurality of parameters include, for example, a job name, a user name, a group name, an application name, the number of requested nodes, and a maximum execution time. In the example of FIG. 13, “TRUE” is set when the parameters match, and “FALSE” is set when the parameters do not match. Further, the success probability of the power consumption prediction for the parameter matching status between a prediction target job of the power consumption prediction and a job used for the prediction is set in percentage units in the determination information 117.

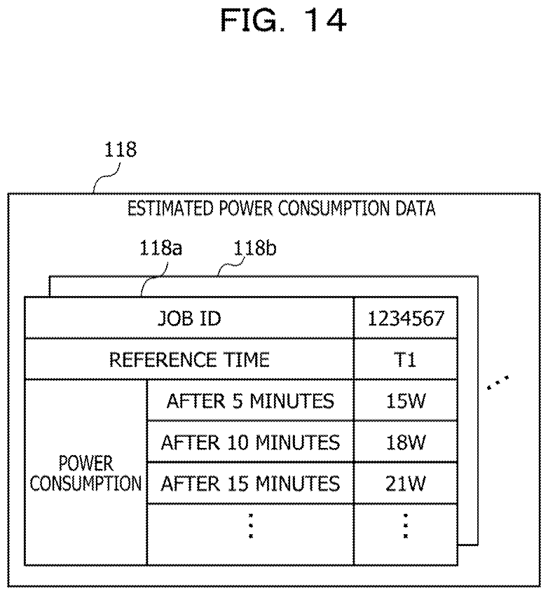

FIG. 14 is a diagram illustrating an example of the estimation result information. The estimation result information 118 includes estimated power consumption data 118a, 118b, . . . for each job before execution or under execution. For example, a job ID, a reference time, and estimated power consumption for each elapsed time from the reference time are set in each of the estimated power consumption data 118a, 118b. . . .

A predicted power consumption for each elapsed time from the start of execution is set in an estimated power consumption data related to a job before execution, among the estimated power consumption data 118a, 118b. . . . Therefore, information (e.g., blank) indicating that the reference time is an execution start time is set in the reference time column of the estimated power consumption data for the job before execution. Further, the time when a power consumption prediction process is executed is set in the reference time column of estimated power consumption data related to a job under execution, among the estimated power consumption data 118a, 118b. . . .

Next, a method of specifying the estimated power consumption of a job before execution by the prediction result correction unit 126 will be described.

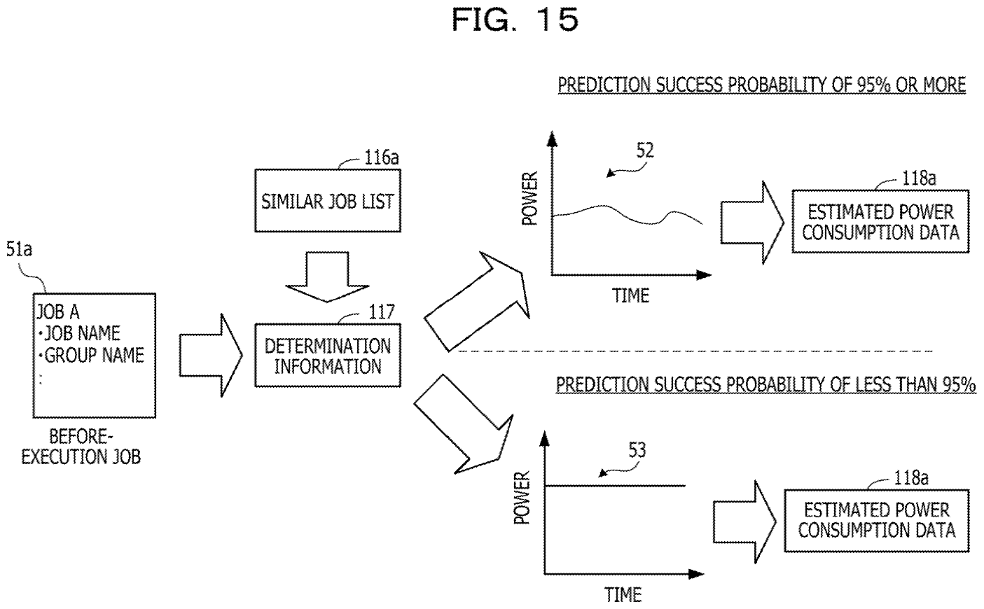

FIG. 15 is a diagram illustrating an example of a method of specifying the estimated power consumption of the job before execution. When a before-execution job 51a is input, the prediction result correction unit 126 determines the estimated power consumption of the before-execution job 51a based on the job status information of the before-execution job 51a.

First, the prediction result correction unit 126 calculates the similarity between a topic distribution of the job status information of the before-execution job 51a and a topic distribution of the job status information of each executed job. The prediction result correction unit 126 registers a predetermined number of jobs in the order of the calculated higher similarity in a similar job list (e.g., the similar job list 116a) for the before-execution job 51a.

Next, the prediction result correction unit 126 specifies the matching status of the parameters between the before-execution job 51a and each of the jobs registered in the similar job list 116a. For example, the prediction result correction unit 126 checks whether a job name, a user name, a group name, an application name, the number of requested nodes, and the maximum execution time set in the job status information match in each of the before-execution job 51a and the jobs registered in the similar job list 116a. Based on the specified matching status of the parameters, the prediction result correction unit 126 determines whether a job with the power prediction success probability of the before-execution job 51a of 95% or more (a similar job for prediction) is present in the jobs registered in the similar job list 116a. For example, the prediction result correction unit 126 refers to the determination information 117 to specify the prediction success probability corresponding to the parameter matching status with the before-execution job 51a for each of the jobs registered in the similar job list 116a.

Then, when it is determined that there is a similar job for prediction, the prediction result correction unit 126 stores a similar job power waveform 52, which is a power waveform of the similar job for prediction, in the estimated power consumption data (e.g., the estimated power consumption data 118a) corresponding to the before-execution job 51a. Further, when it is determined that there is no similar job for prediction, the prediction result correction unit 126 stores a power waveform 53 having a constant power value (the maximum power consumption of the before-execution job 51a) in the estimated power consumption data 118a.

In this way, the prediction result correction unit 126 determines the predicted power consumption as the estimated power consumption of the before-execution job 51a when the prediction success probability of the power consumption of the before-execution job 51a is high, and determines the maximum power consumption as the estimated power consumption of the before-execution job 51a when the prediction success probability is not high.

Next, a method of generating a queue indicating a priority by the ratio adjustment unit 143 will be described.

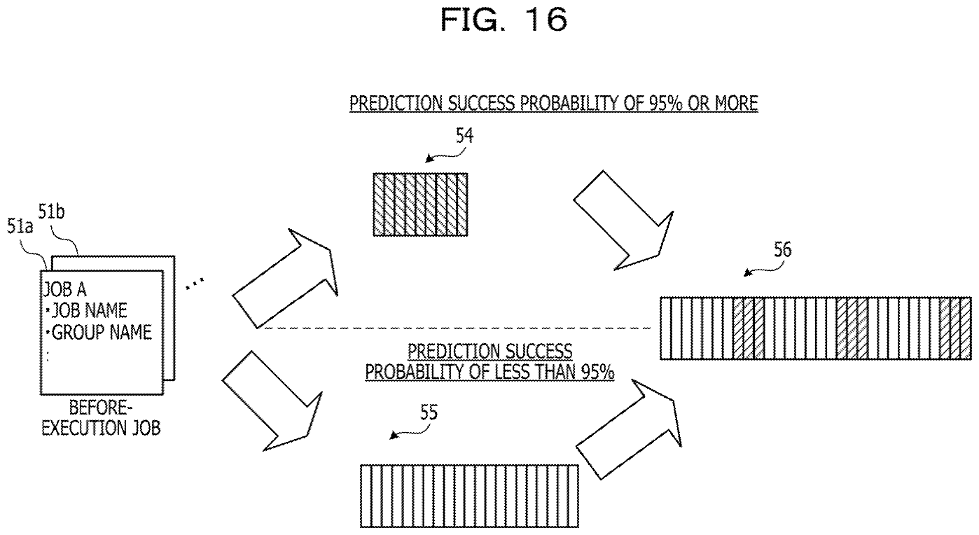

FIG. 16 is a diagram illustrating an example of a method of generating the queue indicating the priority. The ratio adjustment unit 143 generates an execution queue 56 indicating an execution priority of before-execution jobs 51a, 51b, . . . , based on the prediction success probability of the power consumption of the before-execution jobs 51a, 51b. . . .

The ratio adjustment unit 143 classifies the before-execution jobs 51a, 51b, . . . into a job having a higher prediction success probability and a job having a lower prediction success probability. For example, the ratio adjustment unit 143 inputs a job having a prediction success probability of 95% or more (i.e., a job having a similar job for prediction), among the before-execution jobs 51a, 51b, . . . , into a classification queue 54. Further, the ratio adjustment unit 143 inputs a job having a prediction success probability of less than 95% (i.e., a job having no similar job for prediction), among the before-execution jobs 51a, 51b, . . . , into a classification queue 55. In the example of FIG. 16, the horizontal lengths of the classification queues 54 and 55 indicate the total usage amount (e.g., the number of requested nodes×the maximum execution time) of calculation nodes of the input jobs.

Here, for example, it is assumed that the total of “the maximum execution time×the number of requested nodes” of the jobs in the classification queue 54: the total of “the maximum execution time×the number of requested nodes” of the jobs in the classification queue 55 is Y1:Y2. Then, the ratio adjustment unit 143 extracts a job from the classification queue 54 so that the total of “maximum execution time×number of requesting nodes” is Y1×predetermined value Z, and inputs the extracted job into the execution queue 56. Further, the ratio adjustment unit 143 extracts a job from the classification queue 55 so that the total of “maximum execution time×number of requesting nodes” is Y2×predetermined value Z, and inputs the extracted job into the execution queue 56. The ratio adjustment unit 143 inputs jobs from the classification queues 54 and 55 to the execution queue 56 at the above ratio until there are no more jobs in the classification queues 54 and 55.

In this way, the execution queue 56 is generated. The jobs input into the execution queue 56 are prioritized as 1, 2, 3, . . . from the beginning. Further, the jobs input into the execution queue 56 are scheduled with priorities as they are closer to the beginning (i.e., the priority is higher). By scheduling according to the execution queue 56, jobs having a higher prediction success probability and jobs having a lower prediction success probability are executed at a constant ratio.

Next, a method of specifying the estimated power consumption of a job under execution by the prediction result correction unit 126 will be described.

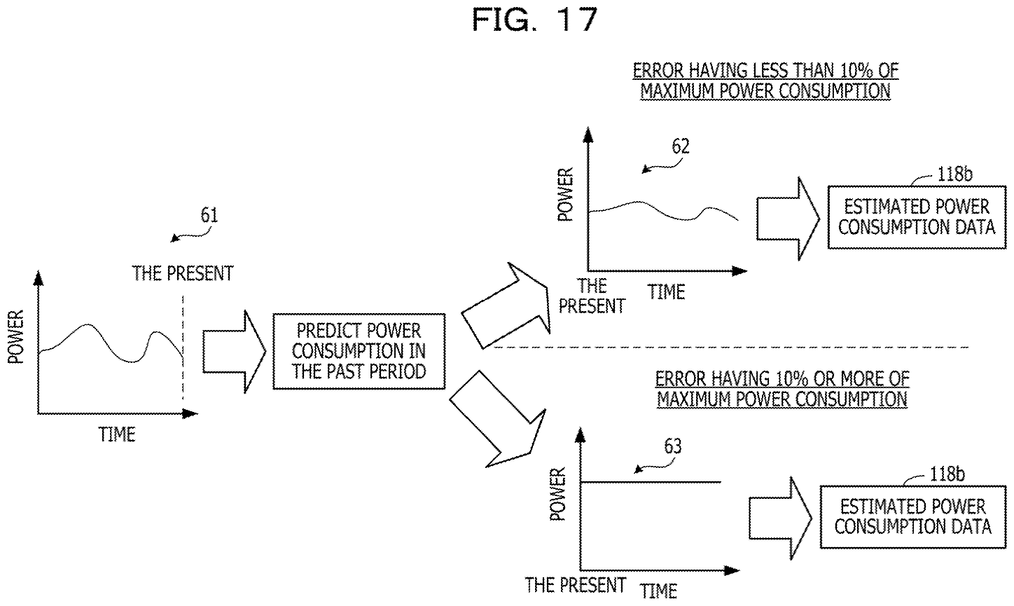

FIG. 17 is a diagram illustrating an example of a method of specifying the estimated power consumption of a job under execution. The prediction result correction unit 126 determines the estimated power consumption of the job under execution based on an under-execution power waveform 61 of the job under execution at regular intervals.

First, the prediction result correction unit 126 calculates an error between the prediction and the actual measurement of the power consumption of the job under execution in the past period. For example, the prediction result correction unit 126 causes the predicted value calculation unit 125 to predict the time-series change of the power consumption from the predetermined time up to the present based on the time-series change of the power consumption up to the predetermined time (e.g., 30 minutes) illustrated in the under-execution power waveform 61. Then, the prediction result correction unit 126 calculates an error between the predicted time-series change of the power consumption from the predetermined time up to the present and the time-series change of the power consumption from the predetermined time up to the present illustrated in the under-execution power waveform 61.

Then, when it is determined that the error between the prediction and the actual measurement of the power consumption of the job under execution in the past period is less than 10% of the maximum power consumption of the job under execution, the prediction result correction unit 126 causes the predicted value calculation unit 125 to calculate a predicted power consumption waveform 62 of a predetermined period after the present. The prediction result correction unit 126 stores the predicted power consumption waveform 62 in the estimated power consumption data (e.g., the estimated power consumption data 118b) corresponding to the job under execution. Further, when it is determined that the error is 10% or more of the maximum power consumption of the job under execution, the prediction result correction unit 126 stores a power waveform 63 having a constant power value (the maximum power consumption of the job under execution) in the estimated power consumption data 118b.

In this way, the prediction result correction unit 126 determines the future predicted power consumption as the future estimated power consumption when the power consumption of the job under execution in the past period may be predicted, and determines the maximum power consumption as the future estimated power consumption when the power consumption of the job under execution in the past period may not be predicted.

Next, a method of generating a prediction model to be used to predict the power consumption of a job under executions will be described. First, a method of generating a data set for generating a prediction model that predicts the power consumption of the job under execution will be described in detail.

As learning to predict the power of a prediction target period, it is conceivable to generate a prediction model based on the time-series power information of all the jobs executed in the past. However, the time-series power data of a job whose execution ends before the prediction target period may not be useful for generating a prediction model for the prediction target period. For example, the time-series power data of a job whose execution ends in less than 30 minutes from the start of execution is not effective for generating a prediction model for estimating the power for a period of 120 to 150 minutes elapsed from the start of job execution. Therefore, for example, the sample creation unit 123 may limit the time-series power data to be used to generate the prediction model to the time-series power data of a job whose execution has been continued until the prediction target period.

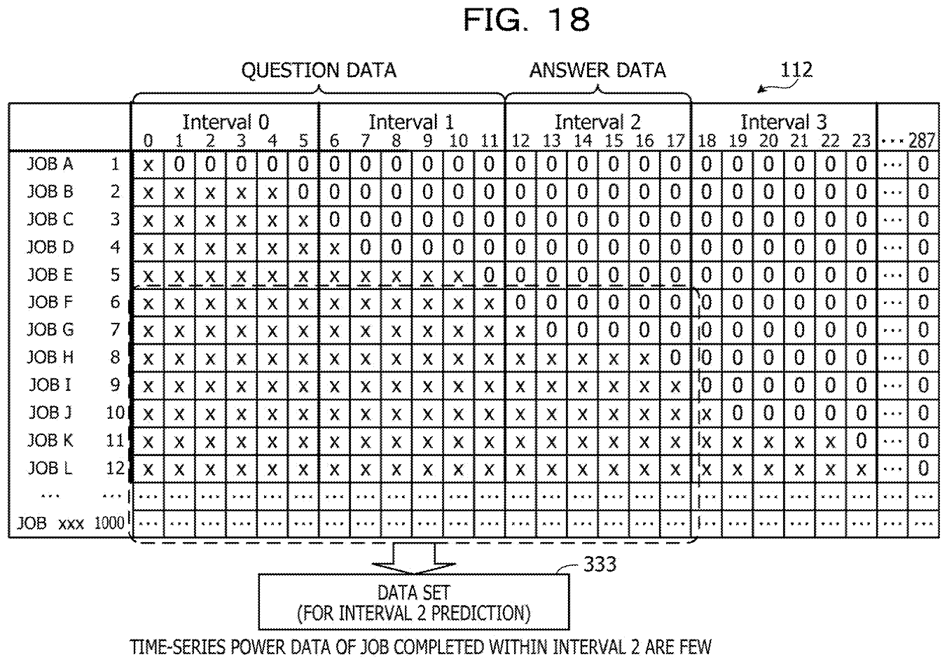

FIG. 18 is a diagram illustrating an example (reference example) of generation of a data set. In the example of FIG. 18, a data set 333 corresponding to the prediction target period of “Interval 2” is generated based on the job power consumption information 112.

In the job power consumption information 112 of FIG. 18, when a power value measured at the time of executing each job is a value other than “0”, “x” is marked in the column of the corresponding measurement point. Further, in the job power consumption information 112, “0” is marked in the column of each measurement point after the execution of each job is completed.

As may be seen from FIG. 18, the length of execution time differs for each job. Therefore, when the time-series power data to be used to generate the prediction model is limited to the time-series power data of the job whose execution has been continued until the prediction target period, the number of power values included in the data set becomes smaller as the time from the start of job execution to the prediction target period becomes longer.

For example, the data set 333 of the prediction target period of “Interval 2” may be created, for example, by the following procedure.

In the example of FIG. 18, jobs “JOB A/B/C/D/E” are completed before “Interval 2”. These jobs are not executed in the “Interval 2” period, and the time-series power data of these jobs may be considered less useful in predicting the power consumption of a job that continues to be executed during the “Interval 2” period. Therefore, the sample creation unit 123 may exclude the measured power values of these jobs from the data set 333 for generation of the prediction model of “Interval 2”.

However, the jobs to be executed include a job, such as “JOB F”, that has been completed immediately after the start of the “Interval 2” period (after a measurement point “11” has elapsed and before a measurement point “12” is reached). In order to correctly predict the power consumption of a job of the same type as “JOB F”, it is desirable that the data set 333 contains a lot of time-series power data of a job that is completed in the same execution time as “JOB F”. However, in the example of FIG. 18, the time-series power data of the job that has been completed within the “Interval 2” period are few. Therefore, in a prediction model generated using the data set 333, since the job is completed within the “Interval 2” period, it is difficult to correctly predict the time-series change of the power consumption of a job whose power consumption becomes “0”.

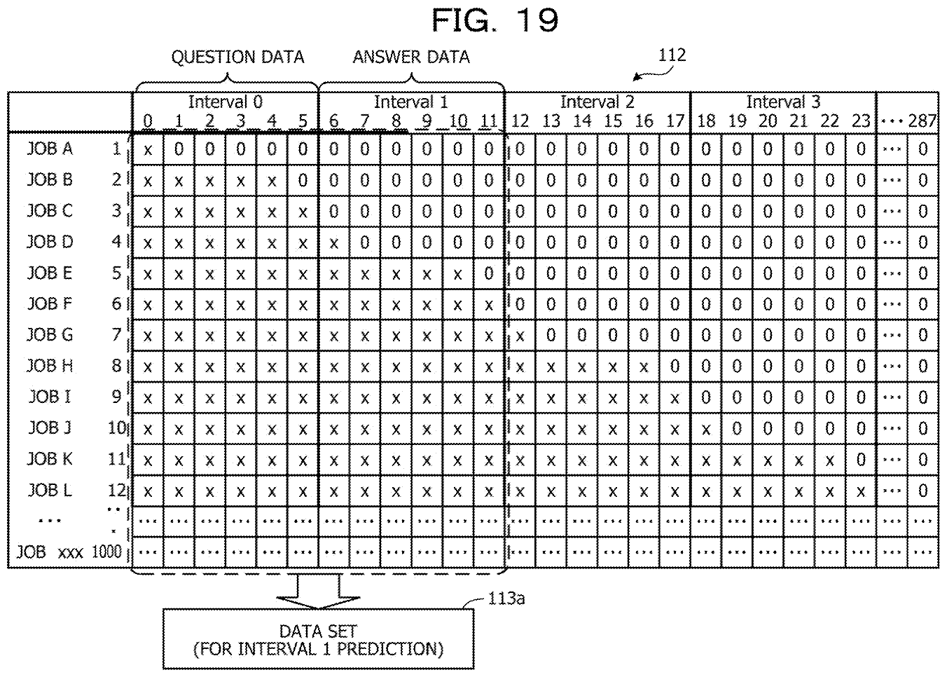

Therefore, the sample creation unit 123 adds the time-series power data of a job completed within a predetermined period up to the prediction target period to the data set. For example, the sample creation unit 123 includes the time-series power data of a job whose end is after a measurement point “6i−5”, in the data set used to predict the power consumption of “Interval i” (i is an integer of 1 or more). Hereinafter, examples of generation of a data set will be described with reference to FIGS. 19 to 21 when the data set includes the time-series power data of the job completed within the predetermined period up to the prediction target period.

FIG. 19 is a diagram illustrating a first example of generation of a data set. In the example of FIG. 19, the data set 113a corresponding to the prediction target period of “Interval 1” (i=1) is generated based on the job power consumption information 112. In this case, the sample creation unit 123 includes the time-series power data of a job completed after a measurement point “1” (6×1−5) in the data set 113a. Of these, power values at measurement points “0 to 5” are question data, and power values at measurement points “6 to 11” are answer data.

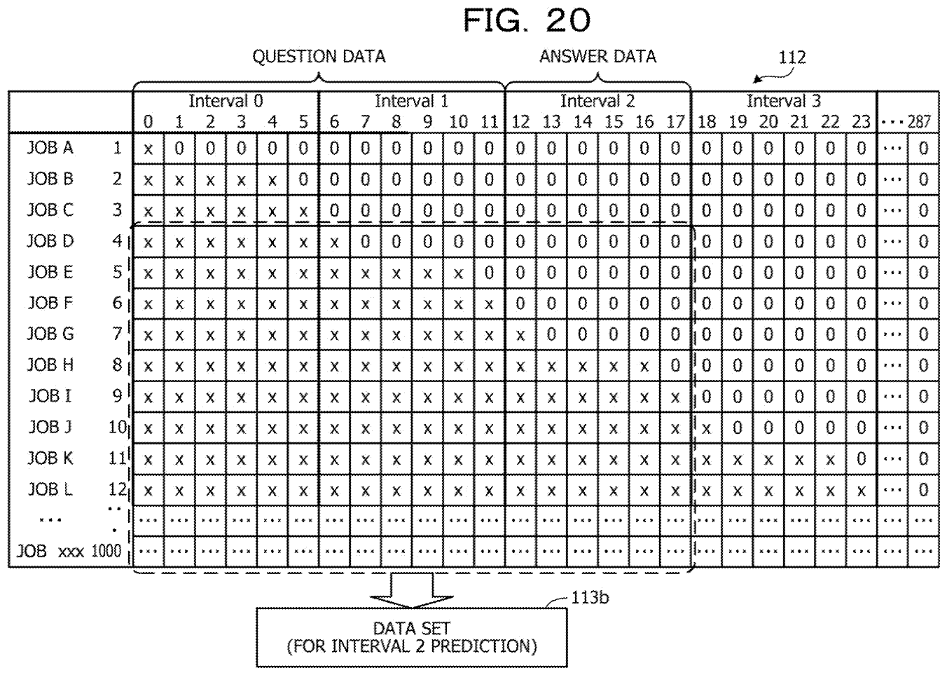

FIG. 20 is a diagram illustrating a second example of generation of the data set. In the example of FIG. 20, the data set 113b corresponding to the prediction target period of “Interval 2” (i=2) is generated based on the job power consumption information 112. In this case, the sample creation unit 123 includes the time-series power data of a job completed after a measurement point “7” (6×2−5) in the data set 113b. Of these, power values at measurement points “0 to 11” are question data, and power values at measurement points “12 to 17” are answer data.

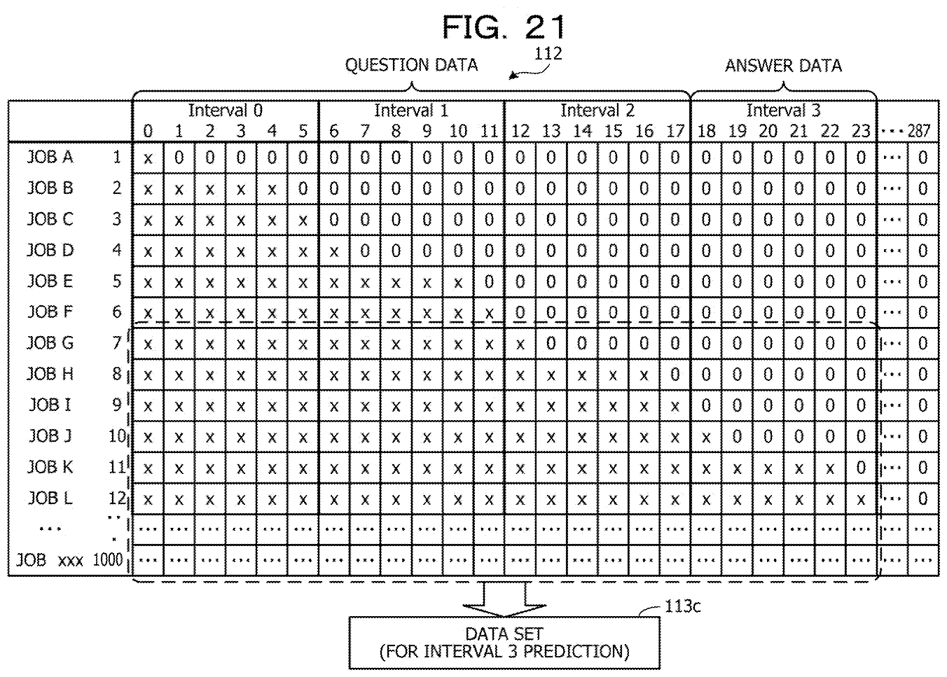

FIG. 21 is a diagram illustrating a third example of generation of the data set. In the example of FIG. 21, the data set 113c corresponding to the prediction target period of “Interval 3” (i=3) is generated based on the job power consumption information 112. In this case, the sample creation unit 123 includes the time-series power data of a job completed after a measurement point “13” (6×3−5) in the data set 113c. Of these, power values at measurement points “0 to 17” are question data, and power values at measurement points “18 to 23” are answer data.

The sample creation unit 123 generates data sets for the subsequent prediction target period in the same manner as the data sets 113a, 113b, and 113c illustrated in FIGS. 19 to 21. Then, the sample creation unit 123 stores a collection of all the generated data sets in the DB 110, as the sample data 113. After that, at a predetermined timing, the learning unit 124 generates a prediction model for each prediction target period based on the sample data 113.

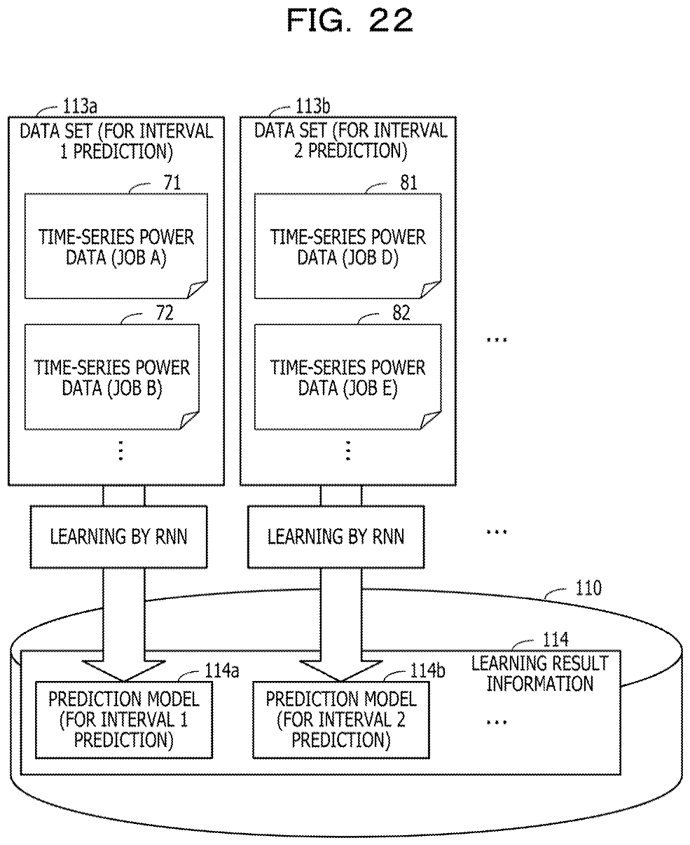

FIG. 22 is a diagram illustrating the outline of a prediction model generating process. For example, the learning unit 124 performs learning by an RNN based on time-series power data 71, 72, . . . for each job included in the data set 113a to generate the prediction model 114a for prediction of the prediction target period of “Interval 1”. Further, the learning unit 124 performs learning by the RNN based on time-series power data 81, 82, . . . for each job included in the data set 113b to generate the prediction model 114b for prediction of the prediction target period of “Interval 2”. After that, similarly, the learning unit 124 also performs learning by the RNN based on the data sets of other prediction target periods to generate prediction models of the other prediction target periods.

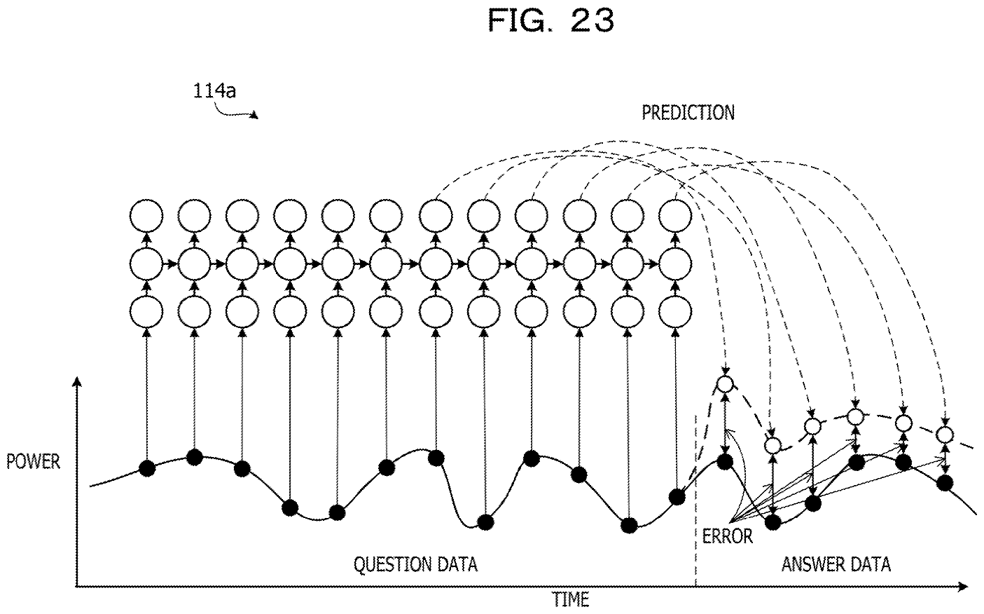

FIG. 23 is a diagram illustrating an example of a prediction model. The example of FIG. 23 illustrates the prediction model 114a that predicts the power of each of the measurement points from one point ahead to six points ahead. The learning unit 124 predicts the power consumption within a prediction target period by the RNN based on question data while reading the data set 113a including the time-series power data of the executed job. Then, the learning unit 124 obtains an error between a predicted value and answer data and learns a parameter of a weight value that reduces the error. For example, the learning unit 124 learns an error between a measured value and the predicted value by a BPTT (Back-Propagation Through Time) algorithm. The BPTT performs an error back propagation of weights of a neural network in the time direction.

When acquiring a measured value of the power consumption of a job under execution, the predicted value calculation unit 125 may predict the power consumption of a similar job for prediction at a plurality of subsequent measurement points by the prediction model 114a as illustrated in FIG. 23.

Next, the process procedure for generating determination information will be described.

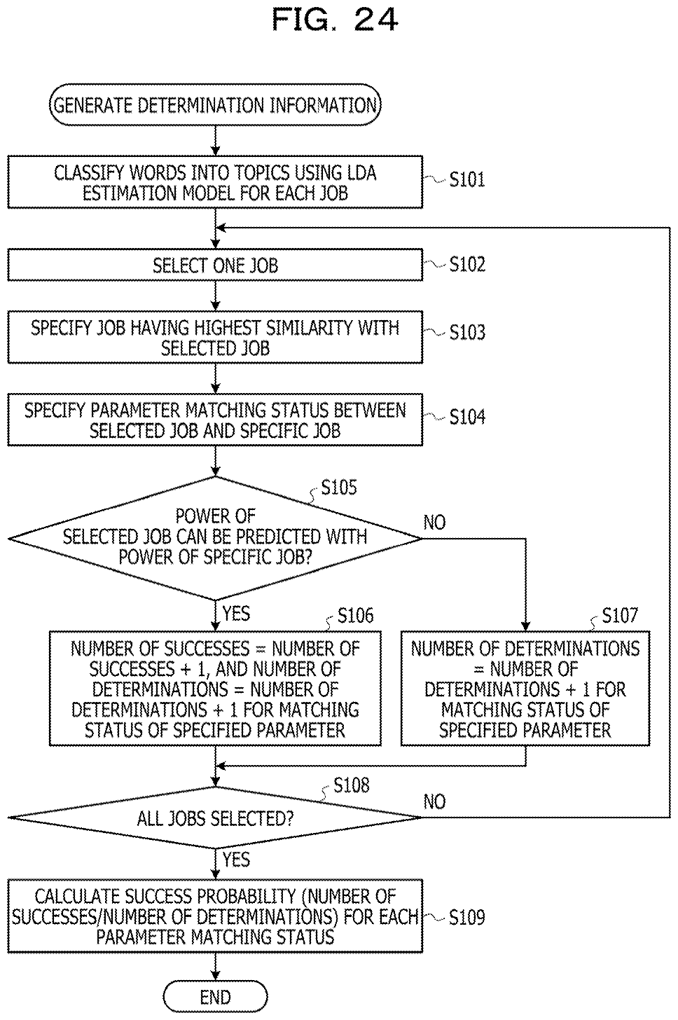

FIG. 24 is a flowchart illustrating an example of a determination information generating process procedure. The process illustrated in FIG. 24 will be described along with operation numbers.

[Operation S101] The learning unit 124 extracts the appearing words in the job status information for each executed job and classifies the words into topics using the LDA estimation model. That is, the learning unit 124 uses the above equation (2) to group words having a high probability of appearing in the common job status information into the same group, and sets the generated group as a topic. The learning unit 124 stores the learning result information 115 indicating the generated topic and a list of words belonging to each topic in the DB 110.

[Operation S102] The learning unit 124 selects one executed job.

[Operation S103] The learning unit 124 specifies a job having the highest similarity with the job selected (selected job) in operation S102 from the executed jobs. For example, the learning unit 124 calculates topic distributions included in the job status information of all the executed jobs based on the learning result information 115. The learning unit 124 calculates the similarity between a topic distribution of the selected job and topic distributions of other executed jobs based on the calculated topic distribution. Then, the learning unit 124 specifies a job having the calculated highest similarity.

[Operation S104] The learning unit 124 specifies the matching status of parameters between the selected job and the job specified (specific job) in operation S103. For example, the learning unit 124 acquires the job status information corresponding to each of the selected job and the specific job. Then, the learning unit 124 refers to the job status information of the selected job and the specific job to specify whether a job name, a user name, a group name, an application name, the number of requested nodes, and the maximum execution time of the selected job and the specific job match.

[Operation S105] The learning unit 124 determines whether the power consumption of the selected job may be predicted with the power consumption of the specific job. For example, the learning unit 124 refers to the job power consumption information 112 to determine whether the average of the squares of errors at each measurement point between the power consumption of the specific job and the power consumption of the selected job is equal to or smaller than a predetermined value. When the average of the squares of errors is equal to or smaller than a predetermined value, it is determined that the power consumption of the selected job may be predicted with the power consumption of the specific job. When the learning unit 124 determines that the power consumption of the selected job may be predicted with the power consumption of the specific job, the process proceeds to operation S106. Otherwise, when the learning unit 124 determines that the power consumption of the selected job may not be predicted with the power consumption of the specific job, the process proceeds to operation S107.

[Operation S106] The learning unit 124 adds 1 to the number of successes and the number of determinations regarding the matching status of parameters specified in operation S104 (the number of successes=the number of successes+1, and the number of determinations=the number of determinations+1). Then, the process proceeds to operation S108.

[Operation S107] The learning unit 124 adds 1 to the number of determinations regarding the matching status of parameters specified in operation S104 (the number of determinations =the number of determinations+1).

[Operation S108] The learning unit 124 determines whether all the executed jobs have been selected. When the learning unit 124 determines that all the executed jobs have been selected, the process proceeds to operation S109. Otherwise, when the learning unit 124 determines that there are still unselected executed jobs, the process proceeds to operation S102.

[Operation S109] The learning unit 124 calculates the prediction success probability (the number of successes/the number of determinations) for each parameter matching status. Then, the learning unit 124 generates the determination information 117 indicating the prediction success probability for the matching status of each parameter and stores the generated determination information 117 in the DB 110.

In this way, the determination information 117 is generated. Then, the prediction result correction unit 126 uses the determination information 117 to specify the prediction success probability of the time-series change of the power consumption of a job before execution.

Next, the process procedure for generating a prediction model will be explained in detail.

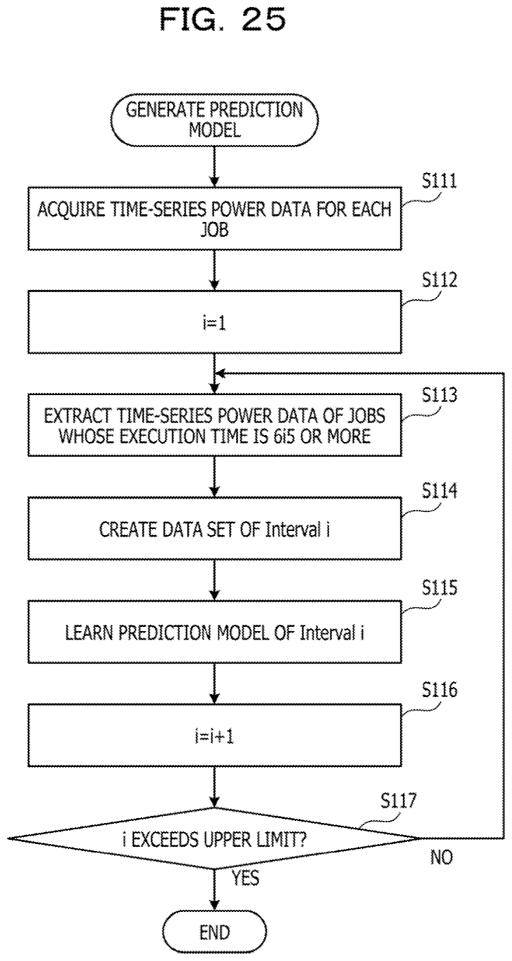

FIG. 25 is a flowchart illustrating an example of a prediction model generating process procedure. Hereinafter, the process illustrated in FIG. 25 will be described along with operation numbers. The prediction model generating process is executed, for example, in response to an instruction output from the timer unit 121 at predetermined time intervals. In the following description, it is assumed that the maximum value of the job execution time is 24 hours and the time width of the prediction target period is 30 minutes. In this case, the upper limit of i in “Interval i” is “47”.

[Operation S111] The metrics collection unit 122 acquires the time-series power data for each job from the DB 130. The metrics collection unit 122 stores the acquired time-series power data as the job power consumption information 112 in the DB 110. At this time, the metrics collection unit 122 sets all power values of measurement points that have not been measured, among measurement points up to the maximum value of the job execution period, to “0”.

[Operation S112] The sample creation unit 123 sets an initial value “1” in a variable i.

[Operation S113] The sample creation unit 123 extracts the time-series power data of jobs having a measurement point “6i−5” or more until the end of execution, from the job power consumption information 112 in the DB 110.

[Operation S114] The sample creation unit 123 creates a data set for learning for creating a model for predicting a prediction target period (measurement points “6i to 6i+5”) of “Interval i”, based on the time-series power data extracted in operation S113. For example, the sample creation unit 123 generates a data set in which the power values of measurement points “0 to 6i−1” are used as question data and the power values of measurement points “6i to 6i+5” are used as answer data. The sample creation unit 123 stores the generated data set in the DB 110.

[Operation S115] The learning unit 124 uses the data set created in operation S114 to learn a prediction model of the prediction target period of “Interval i” by an RNN. The learning unit 124 stores the learned prediction model in the DB 110.

[Operation S116] The sample creation unit 123 adds 1 to the variable i (i=i+1).

[Operation S117] The sample creation unit 123 determines whether the value of i exceeds the upper limit (e.g., “47”). When the sample creation unit 123 determines that the value of i exceeds the upper limit, the process ends. Otherwise, when it is determined that the value of i does not exceed the upper limit, the process proceeds to operation S113.

In this way, a prediction model for each prediction target period is generated. Then, the predicted value calculation unit 125 uses the prediction model to calculate a predicted value of the time-series change of the power consumption in a subsequent predetermined period (e.g., 30 minutes) of a job under execution.

Next, a power estimating process procedure of a job before execution will be explained in detail.

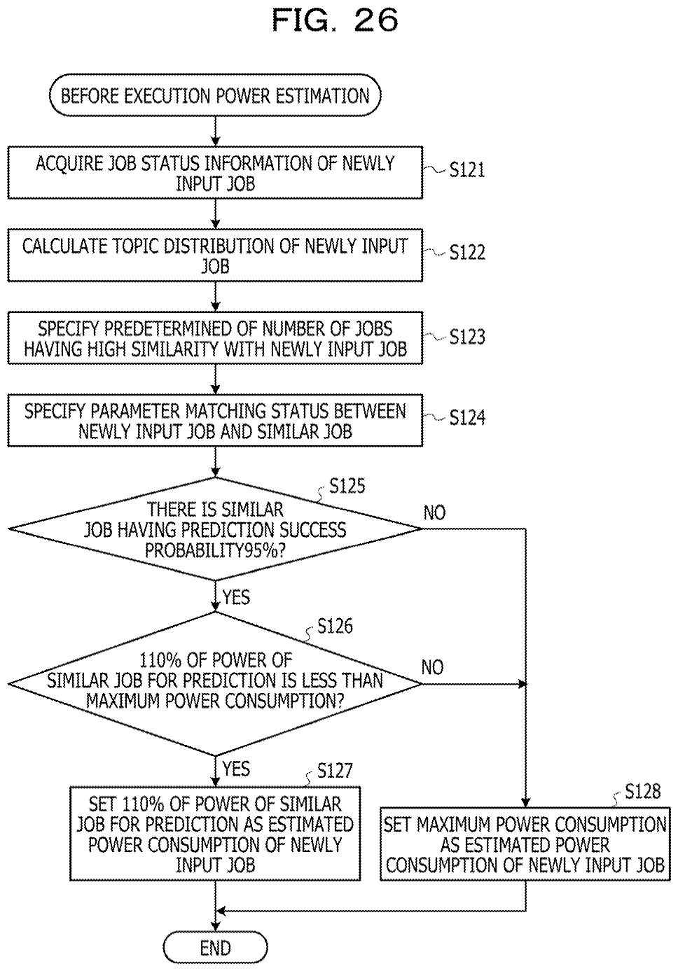

FIG. 26 is a flowchart illustrating an example of a before-execution power estimating process procedure. Hereinafter, the process illustrated in FIG. 26 will be described along with operation numbers. The before-execution power estimating process is executed, for example, when a new job is input.

[Operation S121] The prediction result correction unit 126 acquires the job status information of the newly input job.

[Operation S122] The prediction result correction unit 126 calculates a topic distribution included in the job status information of the newly input job based on the learning result information 115.

[Operation S123] The prediction result correction unit 126 specifies a predetermined number of jobs having the high similarity with the newly input job from the executed jobs. For example, the prediction result correction unit 126 calculates the similarity with the topic distribution of the executed job based on the topic distribution calculated in operation S122. The prediction result correction unit 126 specifies a predetermined number of jobs in the order of the calculated higher similarity. Then, the prediction result correction unit 126 stores a similar job list (e.g., the similar job list 116a) in which the job IDs of the specified predetermined number of jobs are registered, in the DB 110.

[Operation S124] The prediction result correction unit 126 specifies the parameter matching status between the newly input job and the job (similar job) specified in operation S123. For example, the prediction result correction unit 126 acquires the job status information corresponding to the similar job registered in the similar job list 116a. Then, the prediction result correction unit 126 refers to the job status information of the newly input job and the similar job to specify whether a job name, a user name, a group name, an application name, the number of requested nodes, and the maximum execution time for the newly input job and the similar job match.

[Operation S125] The prediction result correction unit 126 determines whether there is a similar job having the prediction success probability of the power of the newly input job of 95% or more. For example, the prediction result correction unit 126 refers to the determination information 117 to specify the prediction success probability corresponding to the parameter matching status of each similar job with the newly input job. Then, the prediction result correction unit 126 determines whether there is a similar job having the specified prediction success probability of 95% or more. When the prediction result correction unit 126 determines that there is a similar job having the prediction success probability of the power of the newly input job of 95% or more, the process proceeds to operation S126. Otherwise, when the prediction result correction unit 126 determines that there is no similar job having the prediction success probability of the power of the newly input job of 95% or more, the process proceeds to operation S128.

[Operation S126] The prediction result correction unit 126 determines whether 110% of the power of the similar job (similar job for prediction) having the prediction success probability of the power of the newly input job of 95% or more is less than the maximum power consumption of the newly input job. For example, the prediction result correction unit 126 determines whether 110% of the power at each measurement point of the similar job for prediction illustrated in the job power consumption information 112 is less than the rated power consumption of the number of requested nodes of the newly input job×1 node. In addition, when there is a plurality of similar jobs having the prediction success probability of the power of the newly input job of 95% or more, the prediction result correction unit 126 regards a similar job having the highest similarity with the newly input job, among the plurality of similar jobs having the prediction success probability of the power of the newly input job of 95% or more, as a similar job for prediction.

When the prediction result correction unit 126 determines that 110% of the power of the similar job for prediction is less than the maximum power consumption of the newly input job, the process proceeds to operation S127. Otherwise, when the prediction result correction unit 126 determines that 110% of the power of the similar job for prediction is equal to or more than the maximum power consumption of the newly input job, the process proceeds to operation S128.

[Operation S127] The prediction result correction unit 126 sets 110% of the power of the similar job for prediction as the estimated power consumption of the newly input job. For example, the prediction result correction unit 126 generates estimated power consumption data (e.g., the estimated power consumption data 118a) corresponding to the newly input job. The prediction result correction unit 126 sets the job ID of the newly input job in the job ID column of the estimated power consumption data 118a and sets the reference time column to blank. Further, the prediction result correction unit 126 sets 110% of the power at each measurement point of the similar job for prediction illustrated in the job power consumption information 112, in the power consumption column of the estimated power consumption data 118a. Then, the prediction result correction unit 126 stores the estimated power consumption data 118a in the DB 110. Then, the process ends.

[Operation S128] The prediction result correction unit 126 sets the maximum power consumption of the newly input job as the estimated power consumption of the newly input job. For example, the prediction result correction unit 126 sets the job ID of the newly input job in the job ID column of the estimated power consumption data 118a and sets the reference time column to blank. Further, the prediction result correction unit 126 sets the rated power consumption of the number of requested nodes of the newly input job×1 node in the power consumption column of the estimated power consumption data 118a. Then, the prediction result correction unit 126 stores the estimated power consumption data 118a in the DB 110.

In this way, the estimated power consumption data 118a indicating the estimated power consumption in scheduling of the newly input job is generated. Based on the determination information 117, the prediction result correction unit 126 determines whether the prediction success probability when the power of the newly input job is predicted with the power of the similar job for prediction is equal to or more than the predetermined value (95%). When the prediction success probability is equal to or more than the predetermined value, the prediction result correction unit 126 sets the power of the similar job for prediction as the estimated power consumption in scheduling of the newly input job. This reduces the estimated power consumption in scheduling of the newly input job. As the estimated power consumption in job scheduling decreases, the number of jobs executed by the HPC system 30 increases. Therefore, the power efficiency of the HPC system 30 is improved.

Meanwhile, when the prediction success probability is less than the predetermined value, the prediction result correction unit 126 sets the maximum power consumption of the newly input job as the estimated power consumption in scheduling of the newly input job. Then, even when it is difficult to predict the power consumption of the newly input job, it is possible to set estimated power consumption larger than the actual power consumption when the newly input job is executed. As a result, scheduling may be performed so that the power consumption of the job does not exceed the rated power consumption of the entire HPC system 30.

Next, an execution ratio adjusting process procedure of a job will be explained in detail.

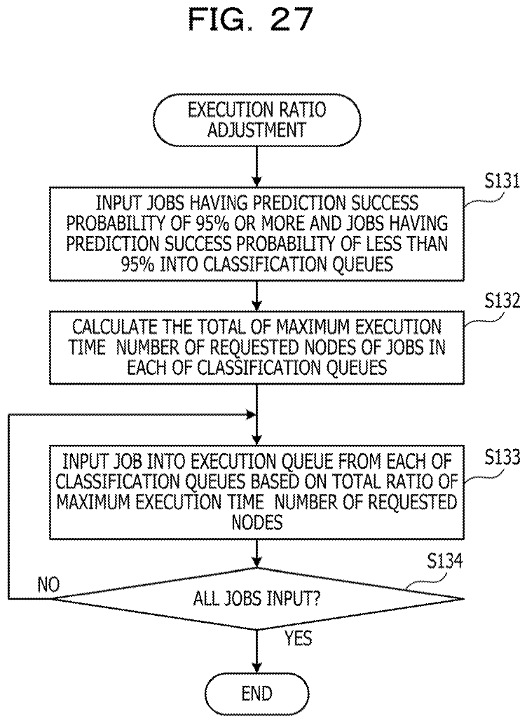

FIG. 27 is a flowchart illustrating an example of an execution ratio adjusting process procedure. Hereinafter, the process illustrated in FIG. 27 will be described along with operation numbers. The execution ratio adjusting process is executed, for example, in response to an instruction output from the timer unit 141 at predetermined time intervals.

[Operation S131] The ratio adjustment unit 143 inputs jobs having the prediction success probability of 95% or more among jobs before execution into the classification queue 54 and inputs jobs having the prediction success probability of less than 95% among jobs before execution into the classification queue 55.

[Operation S132] The ratio adjustment unit 143 calculates the total of “the maximum execution time×the number of requested nodes” of the jobs in each of the classification queues 54 and 55.

[Operation S133] The ratio adjustment unit 143 inputs a job into the execution queue 56 from each of the classification queues 54 and 55 based on the total ratio of “the maximum execution time×the number of requested nodes” of the jobs input into the classification queues 54 and 55. For example, assume that the total of “the maximum execution time×the number of requested nodes” of the jobs in the classification queue 54 : the total of “the maximum execution time×the number of requested nodes” of the jobs in the classification queue 55 is Y1 : Y2. The ratio adjustment unit 143 extracts a job from the classification queue 54 so that the total of “the maximum execution time×the number of requested nodes” is Y1×predetermined value Z, and inputs the extracted job into the execution queue 56. Further, the ratio adjustment unit 143 extracts a job from the classification queue 55 so that the total of “the maximum execution time×the number of requested nodes” is Y2×predetermined value Z, and inputs the extracted job into the execution queue 56.

[Operation S134] The ratio adjustment unit 143 determines whether all the jobs input into the classification queues 54 and 55 have been input into the execution queue 56. When the ratio adjustment unit 143 determines that all the jobs input into the classification queues 54 and 55 have been input into the execution queue 56, the process ends. Otherwise, when the ratio adjustment unit 143 determines that all the jobs input into the classification queues 54 and 55 have not been input into the execution queue 56, the process proceeds to operation S133.

In this way, the ratio adjustment unit 143 inputs jobs before execution into the classification queues 54 and 55 according to the prediction success probability. Then, the ratio adjustment unit 143 inputs the jobs, which are input into the classification queues 54 and 55, into the execution queue 56 according to the ratio of “the maximum execution time×the number of requested nodes” (i.e., the usage amount of calculation nodes 31, 32, . . . ) of the jobs input into each of the classification queues 54 and 55. As a result, jobs with the higher prediction success probability and jobs with the lower prediction success probability are scheduled at a constant ratio. Here, the predicted power consumption is used for the estimated power consumption of the jobs having the higher prediction success probability, and the maximum power consumption of a job is used for the estimated power consumption of the jobs having the lower prediction success probability. Since the maximum power consumption of the job is larger than the predicted power consumption, the number of jobs that may be executed by the HPC system 30 decreases when the execution ratio of jobs whose prediction success probability is not high is biased. Therefore, the ratio adjustment unit 143 increases the number of jobs executed by the HPC system 30 by scheduling the jobs having the higher prediction success probability and the jobs having the lower prediction success probability at a constant ratio. This improves the power efficiency of the HPC system 30.

Next, a power estimating process procedure of a job under execution will be explained in detail.

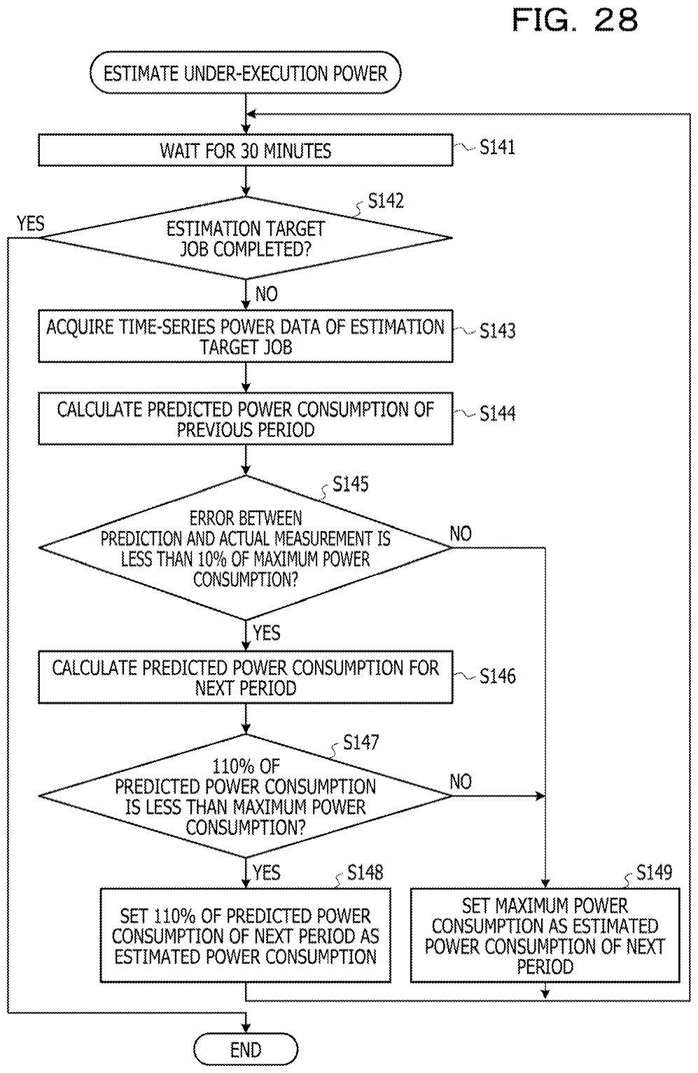

FIG. 28 is a flowchart illustrating an example of an under-execution power estimating process procedure. Hereinafter, the process illustrated in FIG. 28 will be described along with operation numbers. The under-execution power estimating process is executed for each job, for example, when a new job is executed.

[Operation S141] The predicted value calculation unit 125 sets a job whose execution is newly started, as an estimation target job. Then, the predicted value calculation unit 125 waits for 30 minutes from the start of execution of the estimation target job. The waiting time of 30 minutes is measured by, for example, the timer unit 121. In this case, the predicted value calculation unit 125 receives, from the timer unit 121, a notification that 30 minutes have passed, and then the process proceeds to operation S142.

[Operation S142] The predicted value calculation unit 125 determines whether the estimation target job has been completed. For example, when the power consumption of the estimation target job becomes “0”, the predicted value calculation unit 125 may determine that the job has ended. When the predicted value calculation unit 125 determines that the estimation target job has been completed, the process ends. Otherwise, when the predicted value calculation unit 125 determines that the estimation target job has not been completed, the process proceeds to operation S143.

[Operation S143] The metrics collection unit 122 acquires the time-series power data of the estimation target job from the DB 130. Then, the metrics collection unit 122 stores the acquired time-series power data in the DB 110. At this time, the metrics collection unit 122 sets the power value “0” at all the measurement points during a period when there is no power information (from the present to the maximum job execution length). Further, the metrics collection unit 122 sets the power value “0” at all the measurement points up to the maximum job execution length after the end of job is completed even when the job is already completed.

[Operation S144] The predicted value calculation unit 125 calculates the predicted power consumption of the previous period. For example, when 30i minutes have passed from the start of execution of the estimation target job, the predicted value calculation unit 125 sets “Interval (i−1)” as the prediction target period. Then, the predicted value calculation unit 125 predicts the power consumption of the measurement points (e.g., 6 points at 5-minute intervals) at constant time intervals of the estimation target job from 30 minutes before to the present by a prediction model for the prediction target period. For example, the predicted value calculation unit 125 predicts the power consumption of 6 points of “6(i−1) to 6(i−1)+5” measurement points based on the power values of “0 to 6(i−1)−1” measurement points illustrated in the time-series power data of the estimation target job.

When i=1, since the power consumption of the prediction target job from 30 minutes before to the present may not be predicted using the prediction model, the predicted value calculation unit 125 may predict the power consumption of the prediction target job from 30 minutes before to the present based on jobs executed in the past. For example, the predicted value calculation unit 125 sets the power from the start of execution to 30 minutes after the execution start of the similar job for prediction used for power estimation of the estimation target job with the before-execution power estimation process illustrated in FIG. 26, as the predicted power consumption of the estimation target job.

[Operation S145] The prediction result correction unit 126 determines whether an error between the predicted power consumption of the previous period calculated in operation S144 and the actual power consumption (measured power consumption) is less than 10% of the maximum power consumption of the estimation target job. For example, the prediction result correction unit 126 determines whether an error between the predicted power consumption and the measured power consumption is less than the rated power consumption of the number of requested nodesxl node of the estimation target job at all the measurement points of the estimation target job at regular intervals from 30 minutes before to the present. When the prediction result correction unit 126 determines that the error between the predicted power consumption and the measured power consumption in the previous period is less than 10% of the maximum power consumption of the estimation target job, the process proceeds to operation S146. Otherwise, when the prediction result correction unit 126 determines that the error between the predicted power consumption and the measured power consumption in the previous period is equal to or more than 10% of the maximum power consumption of the job estimation target, the process proceeds to operation S149.

[Operation S146] The predicted value calculation unit 125 calculates the predicted power consumption for the next period. For example, when 30i minutes have passed from the start of execution of the estimation target job, the predicted value calculation unit 125 sets “Interval i” as the prediction target period. Then, the predicted value calculation unit 125 predicts the power consumption of the measurement points at constant time intervals of the estimation target job from the present to 30 minutes later by a prediction model for the prediction target period. For example, the predicted value calculation unit 125 predicts the power consumption of 6 points of “6i to 6i+5” measurement points based on the power value of the measurement points “0 to 6i−1” illustrated in the time-series power data of the estimation target job.

[Operation S147] The prediction result correction unit 126 determines whether 110% of the predicted power consumption for the next period calculated in operation S146 is less than the maximum power consumption of the estimation target job. For example, the prediction result correction unit 126 determines whether 110% of the predicted power consumption of the measurement points “6i to 6i+5” is less than the rated power consumption of the number of requested nodesxl node of the estimation target job. When the prediction result correction unit 126 determines that 110% of the predicted power consumption in the next period is less than the maximum power consumption of the estimation target job, the process proceeds to operation S148. Otherwise, when the prediction result correction unit 126 determines that 110% of the predicted power consumption in the next period is equal to or more than the maximum power consumption of the estimation target job, the process proceeds to operation S149.

[Operation S148] The prediction result correction unit 126 sets 110% of the predicted power consumption of the next period calculated in operation S146, as the estimated power consumption of the next period of the estimation target job. For example, the prediction result correction unit 126 sets the current time in the reference time column of estimated power consumption data (e.g., the estimated power consumption data 118b) corresponding to the estimation target job. Further, the prediction result correction unit 126 sets 110% of the predicted power consumption of each of the measurement points “6i to 6i+5” in the power consumption column of the estimated power consumption data 118b in association with each elapsed time at 5-minute intervals from 5 minutes to 30 minutes later. Then, the process proceeds to operation S141.

[Operation S149] The prediction result correction unit 126 sets the maximum power consumption of the estimation target job as the estimated power consumption of the next period of the estimation target job. For example, the prediction result correction unit 126 sets the current time in the reference time column of the estimated power consumption data 118b. Further, the prediction result correction unit 126 sets the rated power consumption of the number of requested nodesx1 node of the estimation target job in the power consumption column of the estimated power consumption data 118b in association with each elapsed time at 5-minute intervals from 5 minutes to 30 minutes later. Then, the process proceeds to operation S141.

In this way, the power in scheduling of the job under execution is estimated. The prediction result correction unit 126 determines whether an error between the predicted power consumption and the measured power consumption of the estimation target job in the previous period is less than a predetermined value. When the error is less than the threshold value, it is highly possible that the future power consumption of the estimation target job may be predicted. Therefore, the prediction result correction unit 126 sets the predicted power consumption of the estimation target job in the next period as the estimated power consumption in the scheduling of the estimation target job. As a result, the estimated power consumption in scheduling of the estimation target job becomes smaller, and accordingly the number of jobs executed by the HPC system 30 increases. Therefore, the power efficiency of the HPC system 30 is improved.

Otherwise, when the error is equal to or more than the threshold value, it is unlikely that the future power consumption of the estimation target job may be predicted. Therefore, the prediction result correction unit 126 sets the maximum power consumption of the estimation target job as the estimated power consumption in scheduling of the estimation target job. Then, even when it is difficult to predict the power of the estimation target job, it is possible to set the estimated power consumption larger than the actual power. As a result, scheduling may be performed so that the power consumption of the job does not exceed the rated power consumption of the entire HPC system 30.

The predicted value calculation unit 125 calculates the predicted power consumption based on the power consumption from the start of execution to the prediction target period. Therefore, since data used for prediction increases as the execution progresses, the prediction accuracy also improves as the execution progresses. Therefore, the prediction result correction unit 126 easily keeps the estimated power consumption low as the execution of the estimation target job progresses.

Next, a job scheduling process procedure will be explained in detail.

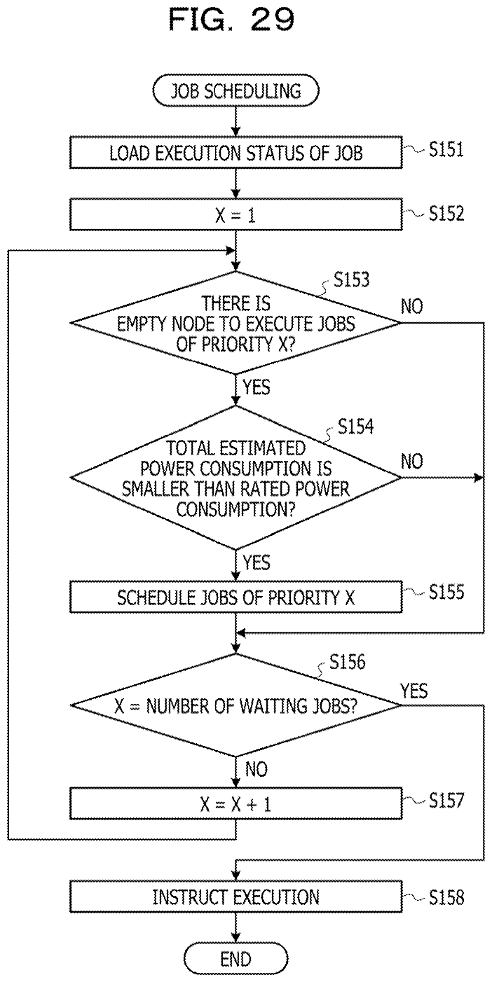

FIG. 29 is a flowchart illustrating an example of a job scheduling process procedure. Hereinafter, the process illustrated in FIG. 29 will be described along with operation numbers. The job scheduling process is executed, for example, when the execution of a job is started or ended.

[Operation S151] The job scheduling unit 144 loads the execution status of a job. For example, the job scheduling unit 144 acquires information on a job before execution and a job under execution by the HPC 30, which is stored in the DB 110, via the ratio adjustment unit 143. Further, the job scheduling unit 144 acquires the execution queue 56 generated by the ratio adjustment unit 143.

[Operation S152] The job scheduling unit 144 sets an initial value “1” in a variable X.

[Operation S153] The job scheduling unit 144 determines whether there is an empty node to execute jobs of a priority X in the execution queue 56. For example, the job scheduling unit 144 refers to the job status information to specify the number of requested nodes for each of the jobs of the priority X, all the jobs under execution, and all the scheduled jobs. When the total number of requested nodes of the jobs of the priority X, all the jobs under executions, and all the scheduled jobs is equal to or less than the number of calculation nodes of the HPC system 30, the job scheduling unit 144 determines that there is an empty node to execute the jobs of the priority X.

When the job scheduling unit 144 determines that there is an empty node to execute the jobs of the priority X, the process proceeds to operation S154. Otherwise, when the job scheduling unit 144 determines that there is no empty node to execute the jobs of the priority X, the process proceeds to operation S156.

[Operation S154] The job scheduling unit 144 determines whether the total estimated power consumption when scheduling the jobs of the priority X is smaller than the rated power consumption of the entire HPC system 30. For example, the job scheduling unit 144 refers to the estimated power consumption data to acquire the current and subsequent power waveforms of each of the jobs of the priority X, all the jobs under execution, and all the scheduled jobs. When there is no time when a power waveform obtained by integrating the acquired power waveforms exceeds the rated power consumption of the entire HPC system 30, the job scheduling unit 144 determines that the total estimated power consumption is smaller than the rated power consumption of the entire HPC system 30.

When the job scheduling unit 144 determines that the total estimated power consumption is smaller than the rated power consumption of the entire HPC system 30, the process proceeds to operation S155. Otherwise, when the job scheduling unit 144 determines that the total estimated power consumption is equal to or more than the rated power consumption of the entire HPC system 30, the process proceeds to operation S156.

[Operation S155] The job scheduling unit 144 schedules the jobs of the priority X.

[Operation S156] The job scheduling unit 144 determines whether the variable X is equal to the number of waiting jobs in the execution queue 56. When the job scheduling unit 144 determines that the variable X is equal to the number of waiting jobs, the process proceeds to operation S158. When the job scheduling unit 144 determines that the variable X is not equal to the number of waiting jobs, the process proceeds to operation S157.

[Operation S157] The job scheduling unit 144 adds 1 to the variable X (X=X+1). Then, the process proceeds to operation S153.

[Operation S158] The control instruction unit 145 instructs the HPC system 30 to execute a job according to a schedule.

In this way, scheduling is performed so that the power consumption of the job does not exceed the rated power consumption of the entire HPC system 30. Next, the above-described scheduling method is compared with Power-Capping, which is another technique for causing the HPC system 30 to execute a job so that the power consumption of the job does not exceed the rated power consumption of the entire HPC system 30.

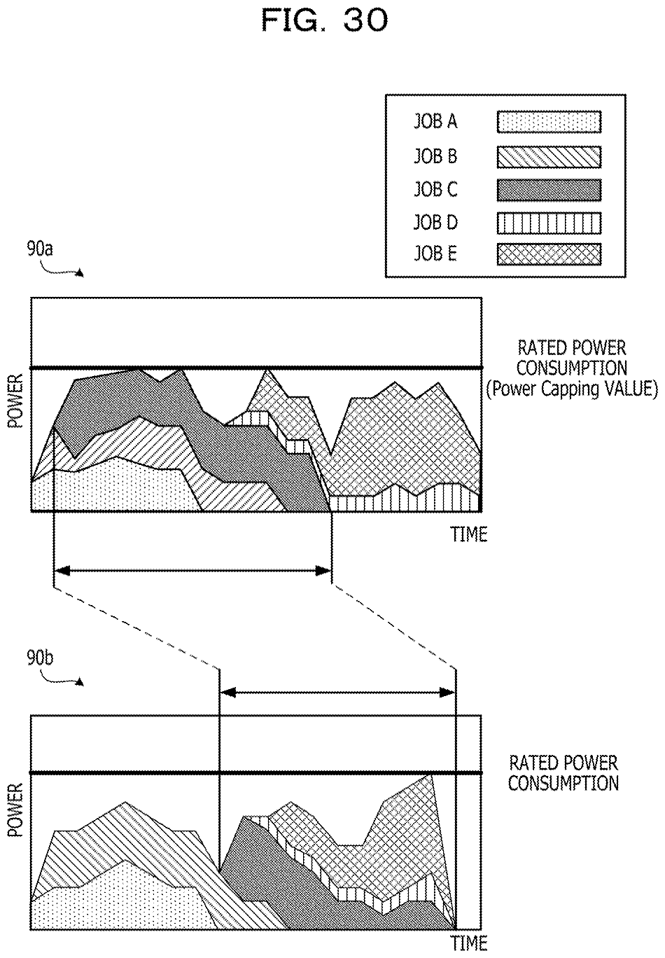

FIG. 30 is a diagram illustrating an example of comparing scheduling methods. An execution result 90a, which is a result of executing a job using Power-Capping, is compared with an execution result 90b, which is a result of executing a job by scheduling so that the power consumption of the job does not exceed the rated power consumption of the entire HPC system 30.

The Power-Capping controls the power consumption of the entire HPC system 30 so that the power consumption of the job does not exceed a Power-Capping value (e.g., the rated power consumption of the entire HPC system 30) by limiting the power for each node. In the execution result 90a using the Power-Capping for the HPC system 30, the HPC system 30 executes a job A, a job B, and a job C in the first half and executes a job D and a job E in the second half. Here, the HPC system 30 executes the jobs so that the power consumption of the job does not exceed the rated power consumption of the entire HPC system 30 by limiting the power consumption for executing each of the jobs A, B, and C by the Power-Capping. Therefore, in the execution result 90a, the execution time of a job (e.g., the job C) is long.

In the execution result 90b in which the power consumption of the job does not exceed the rated power consumption of the entire HPC system 30, the HPC system 30 executes the job A and the job B in the first half and executes the job C, the job D, and the job E in the second half. As a result, in the execution result 90b, the HPC system 30 may execute a job so that the power consumption does not exceed the rated power consumption of the entire HPC system 30 without limiting the power consumption for executing each job.

In this way, the turnaround time (TAT) of the entire HPC system 30 may be shortened by the job scheduling illustrated in the second embodiment.

Although the embodiments have been exemplified above, the configuration of each part illustrated in the embodiments may be replaced with another having the same function. In addition, other arbitrary components and processes may be added. Further, any two or more configurations (features) of the above-described embodiments may be combined with each other.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored job scheduling program that causes a computer to execute a process, the process comprising:
calculating a first predicted power consumption obtained by predicting a power consumption of a first job in a first period based on information before the first period;
when an error between the power consumption of the first job in the first period and the first predicted power consumption is less than a threshold value, at time of scheduling to allocate one or more second jobs to a plurality of calculation nodes so that a total estimated power consumption in a second period after the first period of each of the one or more second jobs including the first job allocated to the plurality of calculation nodes is equal to or less than a predetermined first power, determining an estimated power consumption of the first job in the second period, as a second predicted power consumption obtained by predicting a power consumption when the first job is executed in the second period; and
when the error is equal to or larger than the threshold value, determining the estimated power consumption of the first job in the second period at the time of the scheduling as a predetermined second power.

2. The non-transitory computer-readable recording medium according to claim 1, wherein the first power is determined based on a rated power consumption of all of the plurality of calculation nodes.

3. The non-transitory computer-readable recording medium according to claim 1, wherein the second power is determined based on a total rated power consumption of each of one or more first calculation nodes allocated to the first job among the plurality of calculation nodes.

4. The non-transitory computer-readable recording medium according to claim 1,
wherein, in the calculating of the first predicted power consumption, a time change of the power consumption of the first job in the first period is calculated by using the first predicted power consumption based on a time change of the power consumption of the first job from a start of execution of the first job to a start of the first period, and
wherein, in the determining of the estimated power consumption of the first job in the second period when the error is less than the threshold value, the second predicted power consumption, which is obtained by predicting a time change of the power consumption of the first job in the second period, is determined as the estimated power consumption of the first job in the second period, based on the time change of the power consumption from the start of execution of the first job to a start of the second period.

5. The non-transitory computer-readable recording medium according to claim 1, the process further comprising:
calculating a first prediction success probability of the power consumption in the second period when a third job before execution is allocated to one or more second calculation nodes of the plurality of calculation nodes;
when the first prediction success probability is equal to or larger than a predetermined value, at the time of the scheduling, determining an estimated power consumption of the third job in the second period, as third predicted power consumption which is obtained by predicting the power consumption when the third job is executed in the second period; and
when the first prediction success probability is less than the predetermined value, at the time of the scheduling, determining the estimated power consumption of the third job in the second period, as third power which is determined based on a total rated power consumption of the one or more second calculation nodes.

6. The non-transitory computer-readable recording medium according to claim 5, the process further comprising:
determining priorities allocated to the plurality of calculation nodes at the time of the scheduling of each of a plurality of third jobs before execution, based on a ratio between a usage amount of the plurality of calculation nodes of the third job in which the first prediction success probability is equal to or larger than a predetermined value among the plurality of third jobs and the usage amount of the plurality of calculation nodes of the third job in which the first prediction success probability is smaller than the predetermined value among the plurality of third jobs.

7. The non-transitory computer-readable recording medium according to claim 5,
wherein, in the calculating of the first prediction success probability, when the power consumption of each of a plurality of fourth jobs whose execution is completed is predicted by using other jobs among the plurality of fourth jobs, a second prediction success probability corresponding to a parameter matching status between the third job and a fifth job among the plurality of fourth jobs, which is specified based on determination information indicating the second prediction success probability with respect to the parameter matching status with a job used for prediction, is calculated as the first prediction success probability, and
wherein, in the determining of the estimated power consumption of the third job in the second period, when the first prediction success probability is equal to or larger than the predetermined value, the third predicted power consumption, which is obtained by predicting the power consumption when the third job is executed in the second period based on the power consumption when the fifth job was executed in the past, is determined as the estimated power consumption of the third job in the second period.

8. An information processing apparatus comprising:
a memory; and
a processor coupled to the memory and configured to:
calculate a first predicted power consumption obtained by predicting a power consumption of a first job in a first period based on information before the first period;
when an error between the power consumption of the first job in the first period and the first predicted power consumption is less than a threshold value, at time of scheduling to allocate one or more second jobs to a plurality of calculation nodes so that a total estimated power consumption in a second period after the first period of each of the one or more second jobs including the first job allocated to the plurality of calculation nodes is equal to or less than a predetermined first power, determine an estimated power consumption of the first job in the second period, as a second predicted power consumption obtained by predicting a power consumption when the first job is executed in the second period; and
when the error is equal to or larger than the threshold value, determine the estimated power consumption of the first job in the second period at the time of the scheduling as a predetermined second power.

9. A job scheduling method that causes a computer to execute a process, the process comprising:
calculating a first predicted power consumption obtained by predicting a power consumption of a first job in a first period based on information before the first period;
when an error between the power consumption of the first job in the first period and the first predicted power consumption is less than a threshold value, at time of scheduling to allocate one or more second jobs to a plurality of calculation nodes so that a total estimated power consumption in a second period after the first period of each of the one or more second jobs including the first job allocated to the plurality of calculation nodes is equal to or less than a predetermined first power, determining an estimated power consumption of the first job in the second period, as a second predicted power consumption obtained by predicting a power consumption when the first job is executed in the second period; and
when the error is equal to or larger than the threshold value, determining the estimated power consumption of the first job in the second period at the time of the scheduling as a predetermined second power.
